(19) United States
(12) Patent Application Publication
(10) Pub. No.: US 2018/0184472 A1
(43) Pub. Date: Jun. 28, 2018

(54) COMMUNICATION APPARATUS, COMMUNICATION SYSTEM, AND COMMUNICATION CONTROL METHOD

(71) Applicant: Fujitsu Limited, Kawasaki-shi (JP)

(72) Inventors: Takeshi Ohtani, Kawasaki (JP); Ryuichi Matsukura, Kawasaki (JP)

(73) Assignee: FUJITSU LIMITED, Kawasaki-shi (JP)

(21) Appl. No.: 15/853,063

(22) Filed: Dec. 22, 2017

(30) Foreign Application Priority Data
Dec. 27, 2016 (JP) 2016-253539

(51) Int. Cl. H04W 76/14; H04W 4/80; H04L 12/28

(52) U.S. Cl. CPC H04W 76/14; H04L 63/102; H04L 12/2807; H04W 4/80

(57) ABSTRACT

A communication apparatus configured to transmit data received from a device to a collection apparatus of the data, includes a memory and a processor coupled to the memory and the processor is configured to acquire profile information of a device that connection to the communication apparatus is requested, and to determine whether or not to permit the connection of the requested device to the communication apparatus based on the profile information and design information of devices accommodated to the communication apparatus.

### CROSS-REFERENCE TO RELATED APPLICATION

This application is based upon and claims the benefit of priority of the prior Japanese Application No. 2016-253539 filed on Dec. 27, 2016, the entire contents of which are incorporated herein by reference.

### FIELD

The disclosure relates to a communication apparatus, a communication system, and a communication control method.

### BACKGROUND

Recently, Internet of Things (IoT) service is spreading. In the IoT service, data is collected using apparatuses (also referred to as devices) connected to the Internet. The data is used for service provision and feeds back to the apparatuses and the like.

In order to use the IoT service, apparatuses are installed at a data collection area, and a gateway (GW) relaying communications between the apparatuses and a cloud service is further installed at the data collection area. A communication media used by each apparatus is non-Internet Protocol (non-IP) communications such as Bluetooth, serial communications, and the like, and the GW is disposed when the apparatus cannot communicate with the Internet directly. For further information, see Japanese Laid-Open Patent Publication No. 2006-302297.

### SUMMARY

In order to properly control an apparatus installed at the data collection area, the apparatus and a GW are connected based on a prior system design. An operator performing connection work confirms profile information of each apparatus to be installed and confirms whether or not the profile information matches with design contents.

The profile information is described in, for example, a data sheet provided by a vender of apparatuses. Alternatively, the profile information is stamped or affixed to each apparatus. Alternatively, a work terminal is connected to an apparatus, and the profile information is called up on a screen by command execution. As described above, since a storage location of the profile information and the method of obtaining the profile information are varied, the work of checking the profile information is troublesome and troublesome for the operator. The burden on the workers increases with the number of installed apparatuses.

An aspect of embodiments is a communication apparatus to transmit data received from a device to a collection apparatus of the data. The communication apparatus including a memory, and a processor coupled to the memory and the processor configured to acquire profile information of a device that connection to the communication apparatus is requested, and to determine whether or not to permit the connection of the requested device to the communication apparatus based on the profile information and design information of devices accommodated to the communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 illustrates a configuration example of a data collection system relating to a first embodiment.

FIG. 2 illustrates a configuration example of a device and a gateway.

FIG. 3 illustrates a data structure example of a design information management table.

FIG. 4 illustrates an example of device profile.

FIG. 5 illustrates a data structure example of a configuration information management table.

FIG. 6 illustrates a sequence chart to explain an operation example of the first embodiment.

FIG. 7 illustrates a state that information is added to a configuration information management table.

FIG. 8 illustrates a modify example of a design information management table.

FIG. 9 is a flow chart illustrating an example of device connection process of a gateway in the first embodiment.

FIG. 10 is a flow chart illustrating an example of process of a gateway in a case where a cloud service (a server) performs data communication with a device.

FIG. 11 is a flow chart illustrating an example of process of a gateway in a case where a device transmits data to a cloud service (a server).

FIG. 12 illustrates a configuration example of a system including a plurality of gateways.

FIG. 13 illustrates a relationship between information managed by a management server and information managed by a gateway.

FIG. 14 illustrates a configuration example of second embodiment.

FIG. 15 illustrates a data structure example of a configuration information management table in the second embodiment.

FIG. 16 illustrates a hardware configuration example of an operator terminal in the second embodiment.

FIG. 17 is a flowchart illustrating an example of a process when design information is updated in embodiment 3.

FIG. 18 illustrates a configuration example of embodiment 4.

FIG. 19 illustrates a data structure example of a monitoring object criteria information management table.

FIG. 20 illustrates a data structure example of a communication history management table stored in a storage area.

FIG. 21 is a flow chart illustrating an example of a device connection process in the embodiment 4.

FIG. 22 is a flow chart illustrating an example of a monitoring process executed at a gateway in the embodiment 4.

FIG. 23 illustrates a configuration example of embodiment 5.

FIG. 24 illustrates a data structure example of a policy management table.

FIG. 25 is a flow chart illustrating a process example of a gateway when a device communicates with a server in the embodiment 5.

### DESCRIPTION OF EMBODIMENTS

Hereinafter, embodiments of a communication apparatus and a communication control method will be described with reference to the drawings. A configuration of the embodiments is an example and the present invention is not limited to the configuration of the embodiments.

In the embodiments, as an example, a system (data collection system) to collect data from devices will be described. The collected data is used to provide an IoT service. The IoT service may be provided as a cloud service.

Data outputted from an apparatus (device) is received by a gateway apparatus (GW). The GW transmits to the data collecting apparatus (for example, an information processing apparatus to perform processing of the data). The data collection apparatus is, for example, a server that provides an IoT service.

The GW manages a correspondence relationship between a communication medium included in the apparatus (device) and the acquisition method of a device profile (an example of profile information). In response to link connection between the apparatus and the gateway device (GW), the GW executes profile acquisition process based on the communication medium, and automatically acquires the profile from the apparatus.

For example, when an apparatus communicates with a GW according to Bluetooth Low Energy (BLE), the GW acquires a profile using Device Information Service (DIS) stipulated in the specification of BLE. When the apparatus performs IP communication with the GW, the GW automatically performs processes such Universal Plug and Play (UPnP) and Home-network Topology Identifying Protocol (HTIP: Home Network Connection Configuration Specific Protocol) and the link. UPnP is a protocol that enables to use communication with other apparatuses and functions of other apparatuses instantly without complicated setting work when the apparatus is connected to the communication network.

The GW collates a profile with design information, and permits connection when the profile and the design information match. On the other hand, when the profile and the design information do not match, the GW sets to the apparatus a state in which communication is disabled. For example, with respect to the apparatus, disconnection of a link or setting of communication disabled is performed.

The design information includes information such as a vendor name of the apparatus, a product name. The design information further includes information indicating devices, instruments or functions included in the apparatus for data collection such as a temperature sensor and information indicating a communication medium used in communication between the apparatus and the gateway, and the like. The design information does not include identification information specifying individual apparatus such as the device serial number. As a method of realizing communication cutoff or disconnection, a method corresponding to network configuration of the communication media and the data collection area (also referred to as an installation area of an apparatus or a site) is selected.

For example, the GW explicitly instructs the disconnection in a case where the apparatus is directly accommodated in the GW, as the BLE. The GW also instructs explicit disconnection even when the communication medium is an access point of a wireless LAN providing a disconnection interface (IF). On the other hand, when a physical operation such as serial communication is required for disconnection, the GW prohibits communication at the application layer (layer 7). In this way, the apparatus becomes a state that communication is disabled.

### First Embodiment

### <Configuration>

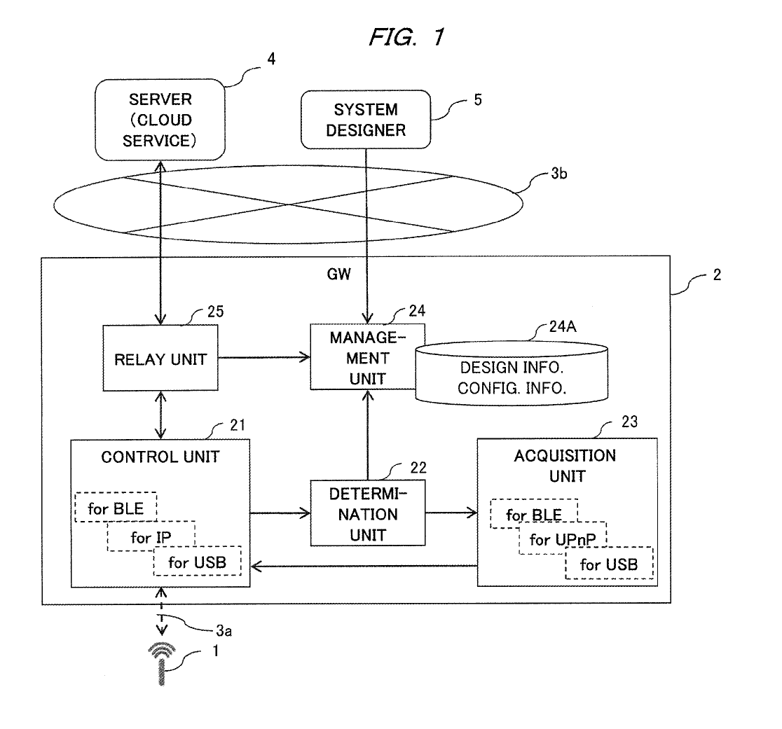

FIG. 1 is a diagram illustrating a configuration example of a data collection system relating to the first embodiment. The system is used that a GW accommodates devices (apparatuses) for collecting data for IoT services at a state matching with predesign. The system designer 5 registers design information in the GW in advance. When a profile of a device (apparatus) to which an operator performs connection work at a data collection place (site) matches the design information, accommodation in the GW is permitted.

In FIG. 1, the data collection system includes a gateway device (GW) 2 that accommodates one or a plurality of devices (apparatuses) 1 to collect data, and a server 4 that communicates with the GW 2 via a network (for example, the Internet) 3. The server 4 provides an IoT service using the data collected by the device 1. For example, the server 4 is connected to the network 3b as a server for providing an IoT service as a cloud service. The GW 2 is an example of “communication apparatus”, the device 1 is an example of “apparatus configured to output data”, and the server 4 is an example of a “collection apparatus of data”.

The GW 2 includes a control unit 21 of device connection, a determination unit 22 of connectability, an acquisition unit 23 of a device profile, a management unit 24 of information, a storage area 24A, and a relay unit 25 of data communication. The control unit 21 controls connection with various devices according to logic that is specific to a communication medium. The determination unit 22 checks the design information and a device profile with detection of the device connection as a trigger and performs a connection permission determination. Communication media include BLE, Bluetooth (other than BLE), IP (Internet Protocol), Universal Serial Bus (USB), wired LAN (Local Area Network), wireless LAN (including WiFi), ZigBee, serial communication and the like. However, communication media other than these may be applied. The device profile is an example of “profile information”.

The acquisition unit 23 uses the control unit 21 and acquires a device profile from the device 1 according to a method (logic) corresponding to a communication medium of the device 1. As described above, when the device 1 and the GW 2 perform communication based on the BLE, the acquisition unit 23 acquires the profile from the device 1 using the DIS. When the device 1 and the GW 2 perform IP communication, the acquisition unit 23 acquires a profile from the device 1 using UPnP and/or HTIP.

The management unit 24 manages design information of a system stored in the storage area 24A and system information (also referred to as configuration information) that is actually constructed. The management unit 24 processes a search request of the device information of the determination unit 22 and updates the system information. The relay unit 25 relays data communication between the device 1 and the server 4 (cloud service) after the device 1 is accommodated in the GW 2. That is, the relay unit 25 receives data addressed to the server 4 from the device 1, transfers the data to the server 4, and transfers the data addressed to the device 1 received from the server 4 to the device.

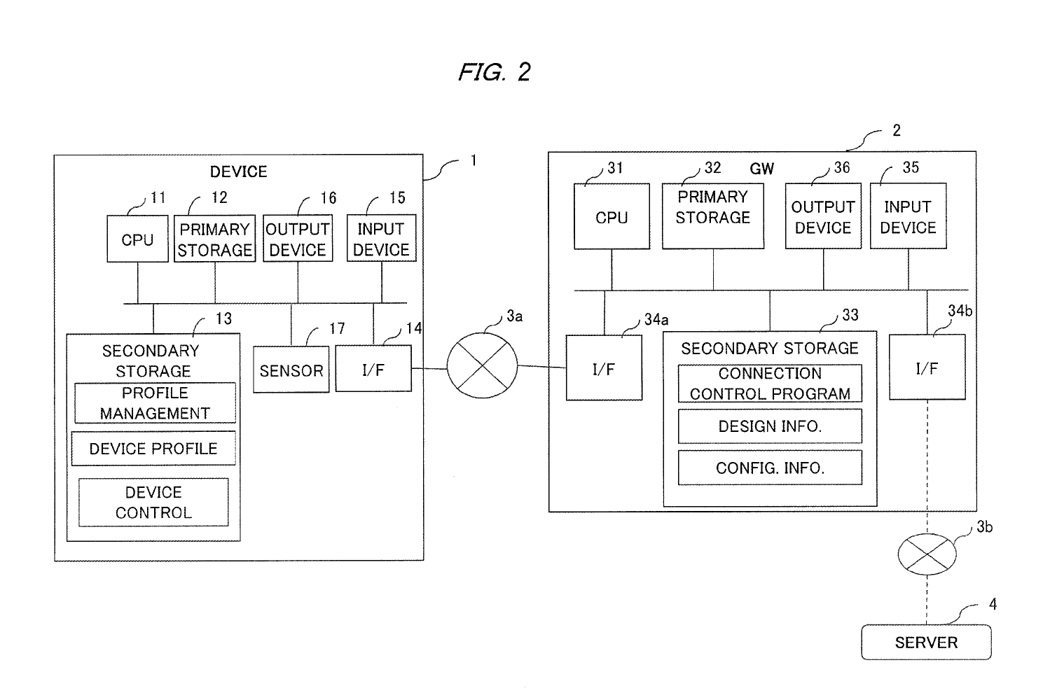

FIG. 2 is a diagram illustrating a hardware configuration example of the device 1 and the GW 2. As an example, the device 1 includes a central processing unit (CPU) 11, a primary storage 12, a secondary storage 13, a communication interface (communication I/F) 14, an input device 15, An output device 16, and a sensor 17. These elements are mutually connected via a bus.

As an example, the GW 2 includes a CPU 31, a primary storage 32, a secondary storage 33, a communication interface (communication I/F) 34 a, a communication IF 34 b, an input device 35, an output device 36, these are mutually connected via a bus.

The primary storage 12 and the primary storage 32 are main storage devices. The main storage device is used as a load area of a program, a work area of a CPU, a storage area of data and programs, a buffer area of communication data, and the like. The main storage device is formed by, for example, a random access memory (RAM) or a combination of a RAM and a read only memory (ROM).

The secondary storage 13 and the secondary storage 33 are auxiliary storage devices. The auxiliary storage device is used as a storage area for data and programs. The auxiliary storage device is formed of a nonvolatile storage medium such as a hard disk drive (HDD), a solid state drive (SSD), a flash memory, an electrically erasable programmable read-only memory (EEPROM), or the like. The auxiliary storage device may include a disk type storage medium. Each of the main storage device and the auxiliary storage device is an example of “storage device”, “storage medium”, “memory”, “storage portion or unit”.

In an example illustrated in FIG. 2, the secondary storage 13 stores a profile management program, a device profile, and a device control program. However, the primary storage 12 may store some of these. The profile processing program and the device control program are executed by the CPU 11, so as to respond to the device profile request from the GW 2, to perform sensing and to transmit a result of the sensing, and to control the device 1. Further, the secondary storage 33 stores a connection control program, design information, and configuration information. However, the primary storage 32 may store part of them.

The communication IF 14, the communication IF 34a, and the communication IF 34b perform communication processing. The communication IF 14 and the communication IF 34a perform processing related to communication using the network 3a. The network 3a is a BLE, a wired LAN, a wireless LAN, or the like. The communication IF 34b performs processing related to communication with the server 4 via the network 3b. The network 3b is, for example, a wired LAN, a wireless LAN, a wireless network based on 3G or 4G (third or fourth generation), a serial communication network, or the like. For example, a network interface card (NIC) is used as the communication IF 34b.

Each of the input device 15 and the input device 35 includes at least one of a key, a button, a pointing device (such as a mouse), a touch panel, a voice input device (microphone), and the like. Each of the output device 16 and the output device 36 includes at least one of a display, a printer, a speaker, a lamp, and the like.

The CPU 11 (the CPU 31) loads and executes the program stored in the secondary storage 13 (the secondary storage 33) into the primary storage 12 (the primary storage 32). By the execution of the program, operations as the device 1 and the GW 2 are performed. The CPU 11 performs a process of supplying a device profile in response to a request from the GW 2, a process of transmitting data acquired by the sensor 17 to the GW 2, and the like. The CPU 11 is an example of “processor configured to transmit a connection request to a communication apparatus configured to transmit data received from a device to a collection apparatus of the data, and to transmit profile information of the device to the communication apparatus in response to the communication apparatus”.

By the execution of the program, the CPU 31 operates as the control unit 21, the determination unit 22, the acquisition unit 23, the management unit 24, and the relay unit 25 illustrated in FIG. 1. At least one of the primary storage 32 and the secondary storage 33 is used as the storage area 24A. The CPU 31 is an example of “acquisition unit”, “determination unit”, “management unit”, and “control unit”.

The CPU (each of the CPU 11 and the CPU 31) is an example of “control device”, “control unit”, “controller” and “processor”. The CPU is also called MPU (Microprocessor), processor. The CPU is not limited to a single processor but may be a multiprocessor configuration. Also, a single CPU connected by a single socket may have a multi-core configuration. At least a part of the processing performed by the CPU 11 may be executed by a multi-core or a plurality of CPUs. At least a part of the processing performed by the CPU 11 is performed by dedicated processors such as a processor other than the CPU, for example, a digital signal processor (DSP), a graphics processing unit (GPU), a numerical operation processor, a vector processor, an image processing processor and the like.

At least a part of the processing performed by the CPU (each of the CPU 11 and the CPU 31) may be performed by an integrated circuit (IC) or another digital circuit. Further, the integrated circuit and the digital circuit may include an analog circuit. The integrated circuit includes an LSI, an Application Specific Integrated Circuit (ASIC), and a programmable logic device (PLD). The PLD includes, for example, a field-programmable gate array (FPGA). At least a part of the processing performed by the CPU 11 may be executed by a combination of the processor and the integrated circuit. The combination is called, for example, a microcontroller (MCU), a system-on-a-chip (SoC), a system LSI, a chip set or the like.

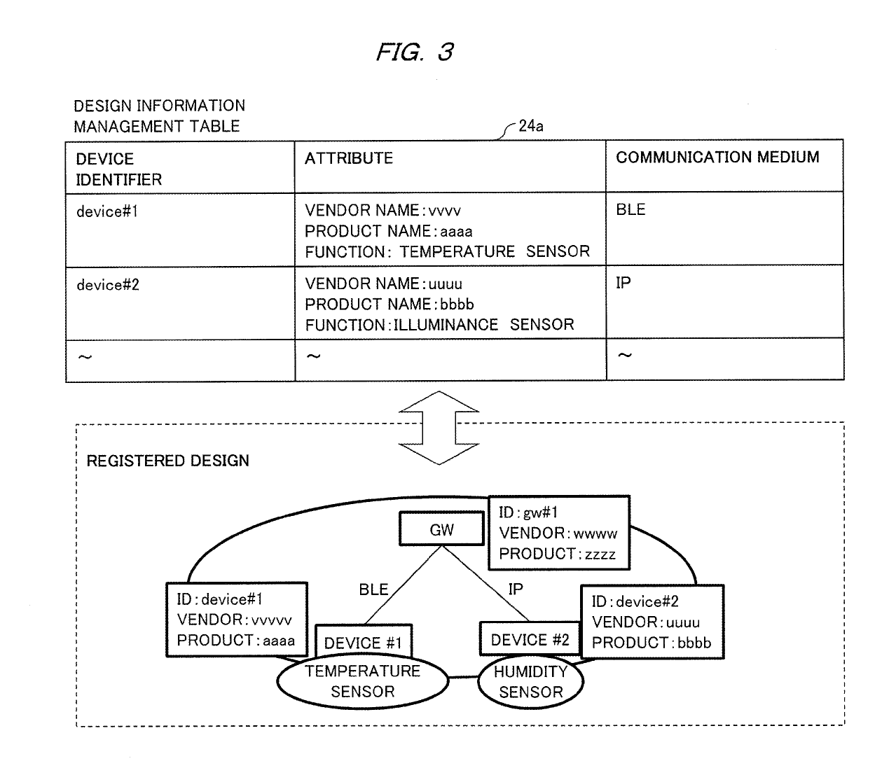

The operation at the time of connecting the device 1 with the GW 2 is as follows. As a premise, the system designer 5 registers the design information of the system in advance (beforehand) in the storage area 24A. FIG. 3 illustrates an example of a data structure of a design information management table 24a (table 24a).

The table 24a has entries corresponding to each device. The entry includes an identifier of the device, information indicating the attribute, and information indicating the communication medium. The device identifier is an identifier of a device constituting the system. The attribute information includes information for specifying a device constituting the system, such as characteristics possessed by the device 1. As an example, in FIG. 3, a vendor name, a product name, and a function are included in elements of the attribute information. However, information specifying individual devices is not included. The communication medium indicates a communication medium used for the device 1 connecting to the GW 2.

In the example illustrated in FIG. 3, a device #1 identified by the identifier of “device #1” has a vendor name “vvvv”, a product name “aaaa” and a function “temperature sensor”. Also, the device #1 is connected to the GW 2 according to BLE. A device #2 identified by the identifier of “device # 2” has a vender name “uuuu”, a product name “bbbb”, and a function “illuminance sensor”. Also, the device #2 is connected to the GW 2 according to IP.

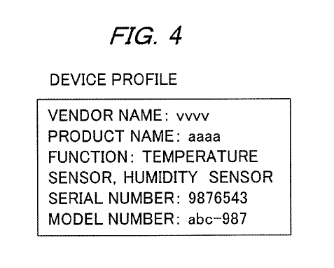

FIG. 4 illustrates an example of a device profile. The device profile includes a vendor name, a product name, information indicating functions, individual identification information such as a serial number and/or a model number.

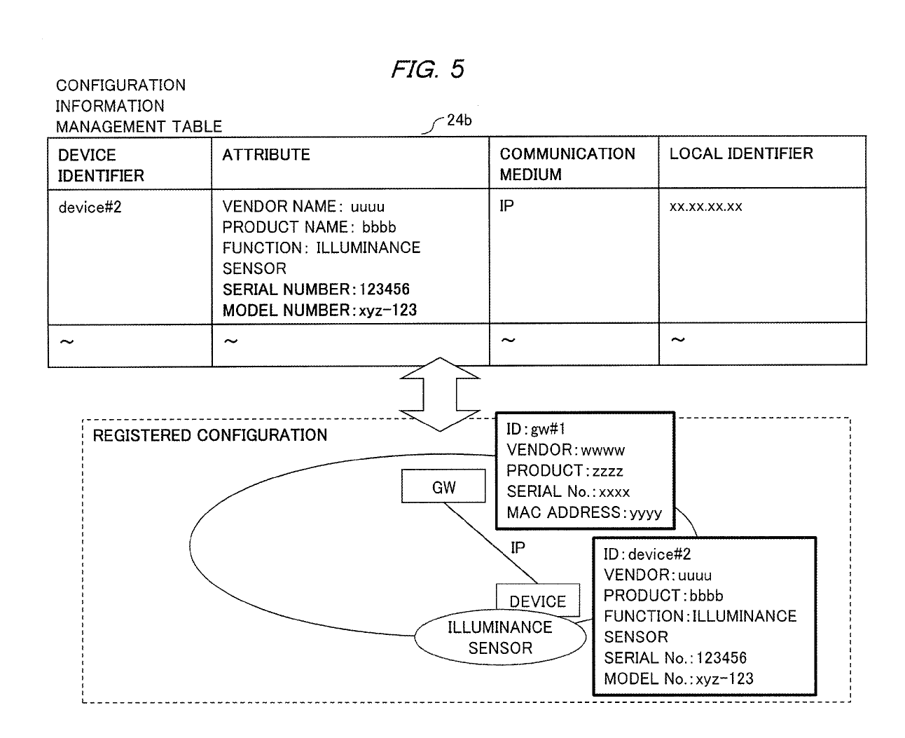

FIG. 5 is a diagram illustrating a data structure example of the configuration information management table 24b (table 24b). The table 24b has entries corresponding to each device. The entry includes a device identifier, information indicating an attribute, information indicating a communication medium, and a local identifier.

The device identifier is an identifier of a device (device 1). The information indicating the attribute is information indicating an attribute for specifying each device forming the system. In addition to the information indicating the vendor name, the product name, and the function, the information indicating the attribute includes information for identifying or specifying each device 1 such as serial number or model number. The communication medium indicates a communication medium used for the device 1 connecting to the GW 2. The local identifier is an identifier (address) used when the GW 2 accesses the device (device 1) with a predetermined communication medium in response to a device access request from the cloud service (server 4).

### <Operation Example>

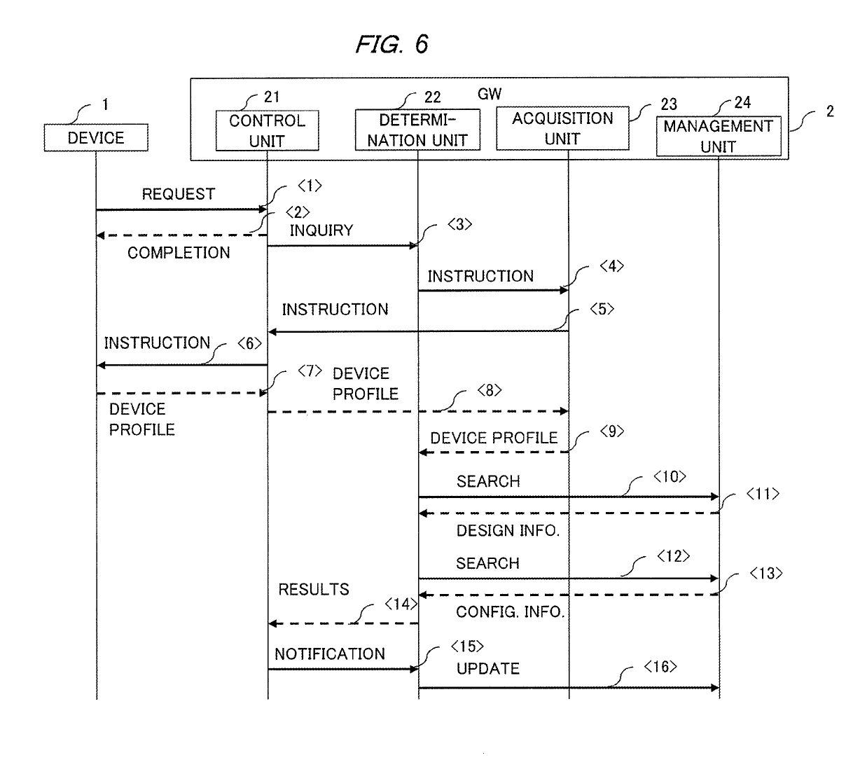

Hereinafter, an operation example in the first embodiment will be described. FIG. 6 is a sequence diagram illustrating an operation example of the first embodiment. The control unit 21 waits for communication corresponding to each communication medium provided in the GW 2. For example, when the GW 2 includes the communication IF 34a for BLE, the BLE device as the device 1 is periodically scanned, and the BLE device transmits a link connection request near the GW 2 (advertisement: see <1> in FIG. 6).

The control unit 21 detecting the advertisement (link connection request) automatically transmits a connection request to the device 1 and performs connection processing (<2> in FIG. 6). This connection is a provisional connection made to obtain the device profile. This series of operations may be performed by giving an instruction from a site work terminal capable of communicating with the GW 2 at a site worker.

When the control unit detects the connection between the device 1 and the GW 2, the control unit 21 notifies the determination unit 22 of the device communication media and an identifier of the device in the device communication medium (<3> in FIG. 6). For example, when the communication medium is BLE, the device identifier is a BD (Bluetooth Device) address of the device 1. When the device 1 is an IP communication device, a device identifier is a MAC (Media Access Control) address or the like.

The acquisition unit 23 receives an acquisition instruction of a device profile from the determination unit 22 (<4> in FIG. 6), and determines a device profile acquisition method according to the communication medium of the device 1. The acquisition unit 23 acquires a profile using the determined method (<5> to <8> in FIG. 6). That is, a providing request of a profile is transmitted from the GW2 (<5> and <6> in FIG. 6), and the device 1 transmits the profile (FIG. 4) to the GW (<7> and <8> in FIG. 6).

For example, when the communication medium is BLE, information such as a vendor name, a product name, serial number, etc. is acquired as a profile by DIS via the BLE connection of the control unit 21. If the device 1 is an IP communication device, profile acquisition is performed by UPnP. Since device search by UPnP performs multicast communication, there is a possibility that responses from a plurality of devices are received. In this case, by using the device identifier (in a case of IP, MAC address) in the communication media, the target device is specified.

Note that, when at least a part of IP communication devices do not support UPnP, for example, a database (DB) storing MAC address of the device 1 (included in the connection request) and attribute information of the device 1 may be prepared in advance and the DB may be referred to. Further, the device 1 may have a function of transmitting the profile of the device 1 itself.

The determination unit 22 acquires the profile of the device 1 from the acquisition unit 23 (<9> in FIG. 6), and passes the communication medium name and the profile to the management unit 24 (<10> in FIG. 6). The management unit 24 searches for design information matching the profile. Specifically, the management unit 24 refers to the design information management table 24a (see FIG. 3), and searches an entry that information obtained from the device 1 matches “communication medium” and information indicated in “attribute” is included in the profile. The management unit 24 determines a device identifier included in the searched entry as an identifier of the device 1. The retrieved design information is passed to the determination unit 22 (<11> in FIG. 6).

For example, it is assumed that a profile having contents illustrated in FIG. 4 is acquired from the device 1 being a BLE device. This profile matches “device #1” in the design information management table 24a having the contents illustrated in FIG. 3. In this case, the identifier “device #1” is allocated to the device 1.

With respect to the “function” in the “attribute”, it is sufficient if the profile includes the function specified in the design information. Further, in some cases, design information may specify a plurality of vendor names or a plurality of product names. Alternatively, if a device has a predetermined function, operation regardless of vendor name and product name may be performed. In these cases, candidates and regular expressions related to a plurality of vendor names, a plurality of product names, and a plurality of functions may be described in “attribute” of the design information (table 24a).

The management unit 24 searches the configuration information management table 24b (see FIG. 5) for managing the information on a connected device (device 1) (<12> in FIG. 6) and passes it to the determination unit 22 (<13> in FIG. 6). This process is performed to confirm that a corresponding device (device 1) is not yet connected. This process is performed in order to avoid that two or more devices having the same type are accommodated in the GW 2.

The determination unit 22 determines permission or rejection of connection based on the design information and the configuration information. For example, it is assumed that the determination unit 22 receives an entry of the table 24a including an identifier “device #1” or the identifier “device #1” as the design information and receives, as the configuration information, an entry of the table 24b that matches the identifier “device #1”.

When the entry of the table 24b has the contents illustrated in FIG. 5, it can be seen that the device 1 to which the identifier “device #1” is allocated is not yet accommodated in the GW 2 from the registered contents of the table 24b. Therefore, the determination unit 22 permits the connection. At this time, for example, through a terminal of a site worker, a worker may be asked to confirm whether it is possible to finally connect.

The determination unit 22 returns a determination result (permitted or refusal) to the control unit 21 (<14> in FIG. 6). When the determination result is “permitted”, processing for handling the provisional connection as a formal connection is performed. This processing may be unnecessary in some cases. If rejected, disconnection processing is performed if the communication media is capable of explicit disconnection, if not, link connection is maintained and data relay between the devices 1 and the cloud service (the server 4) is prohibited.

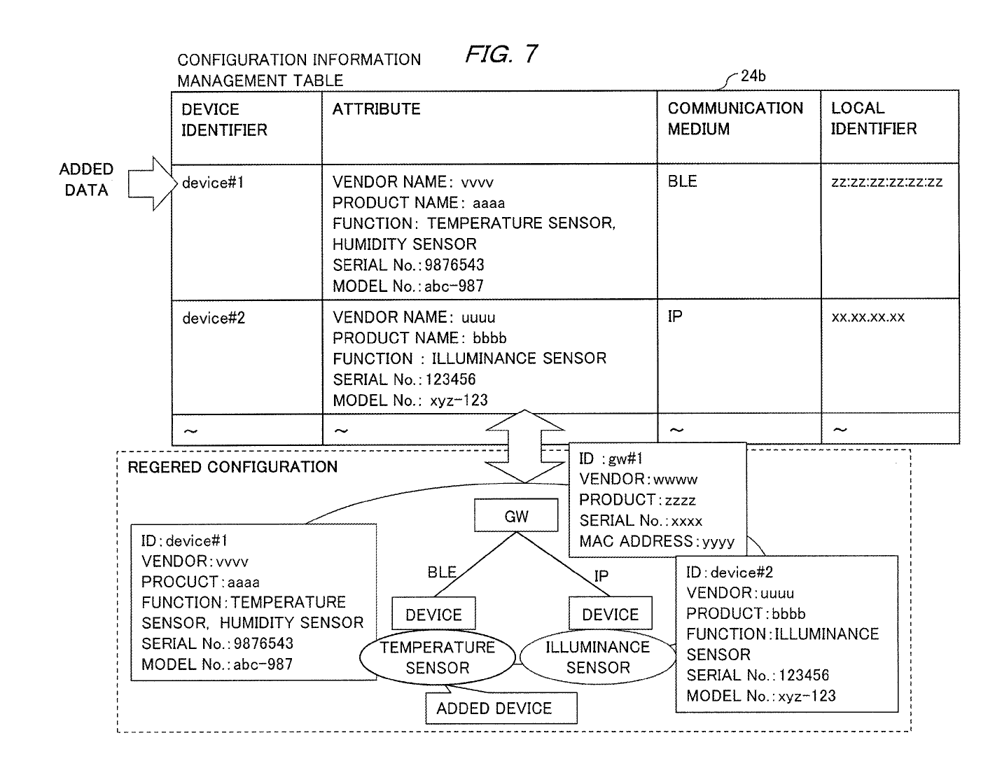

Upon completion of the connection, the control unit 21 notifies the determination unit 22 of a result of the connection processing (<15> in FIG. 6), and the determination unit 22 instructs the management unit 24 to register the profile of the actually connected device (<16> in FIG. 6). The management unit 24 registers the profile in the configuration information (table 24b). By the registration, the contents of the table 24b become the contents illustrated in FIG. 7.

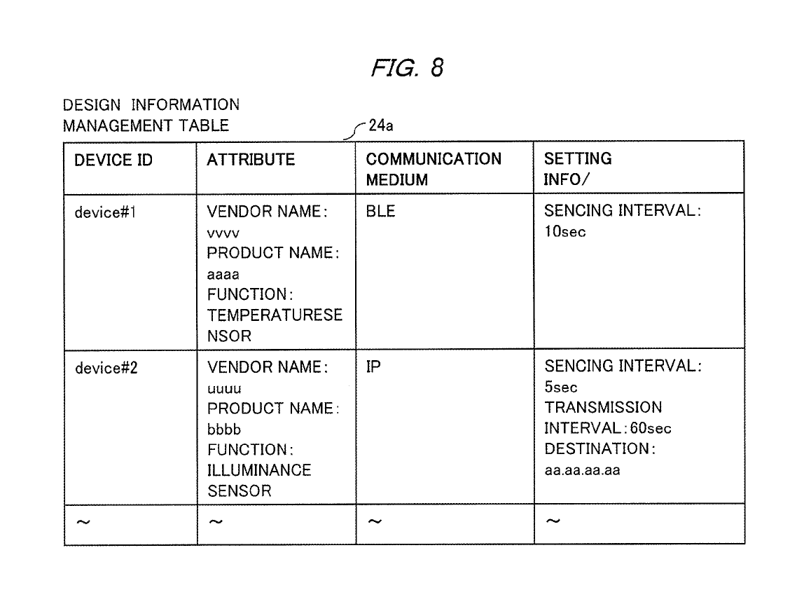

As a modification of the design information management table 24a, as illustrated in FIG. 8, each entry may include setting information for the device 1. In this case, the management unit 24 may automatically perform the setting of the device 1 based on the configuration information when the connection between the device 1 and the GW 2 is completed.

### <Device Connection Processing in GW>

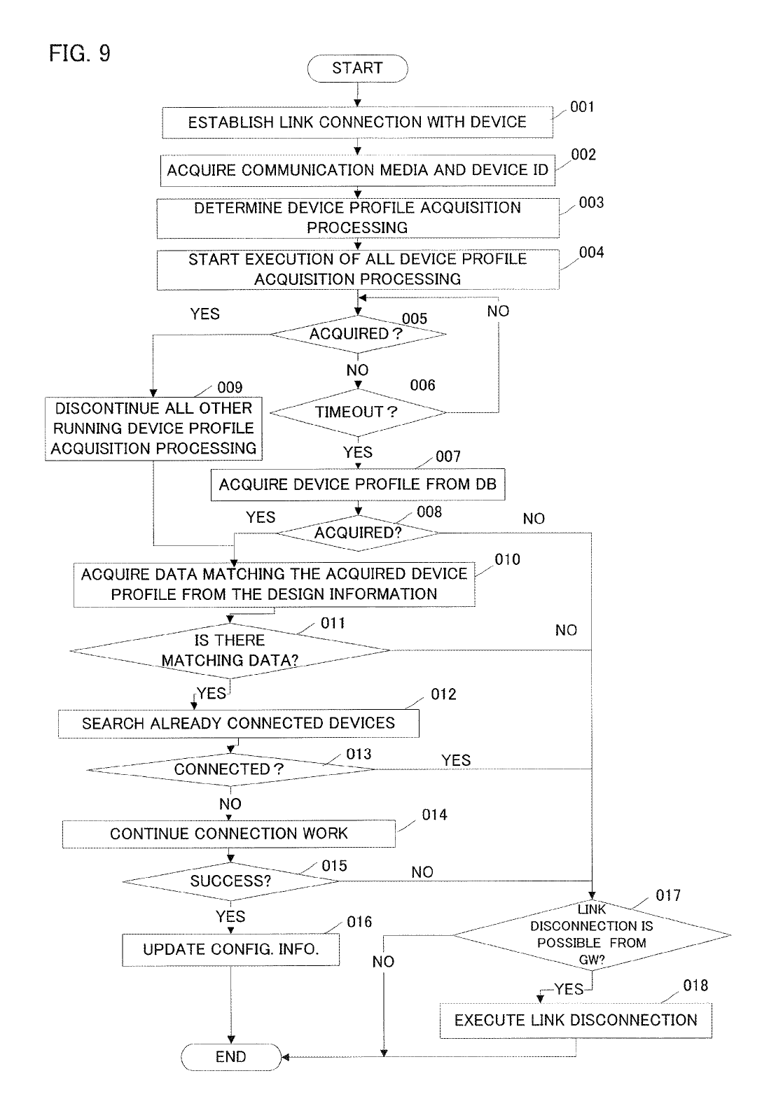

FIG. 9 is a flowchart illustrating an example of device connection processing of GW 2 according to the first embodiment. The process illustrated in FIG. 9 is executed by the CPU 31 of the GW 2, for example. In a process of 001, the GW 2 establishes the link connection with the device 1 according to the procedure corresponding to the communication medium of the device 1.

In a process of 002, the GW 2 acquires a communication medium with which the link connection is established and a device identifier on this communication medium. In a process of 003, the GW 2 determines acquisition processing (acquisition method) of a device profile (also simply referred to as a profile) corresponding to the communication medium.

In a process of 004, the GW 2 starts executing the acquisition processing regarding profiles of all the devices 1. Based on the acquisition method determined at 003, an instruction to transmit the profile is sent to the device 1. The CPU 11 of the device 1, by executing the program, performs a process of reading the profile stored in at least one of the primary storage 12 and the secondary storage 13 in accordance with an instruction to transmit the profile from the GW 2 received by the communication IF 14 and a process of transmitting the profile from the communication IF 14.

In a process of 005, the GW 2 determines whether or not the profile transmitted from the device 1 is acquired. When it is determined that the profile is acquired, the device connection processing proceeds to a process of 009, and if not, the device connection processing proceeds to a process of 006.

In the process of 006, the GW 2 determines whether or not the acquisition processing is timeout. If it is determined that the acquisition processing is not timeout, the device connection processing returns to the process of 005. On the other hand, if it is determined that the acquisition processing is timeout, the device connection processing proceeds to a process of 007.

In the process of 007, the GW 2 acquires the profile from a database created in advance. In a process of 008, the GW 2 determines whether or not the profile is acquired. If it is determined that the profile is acquired, the device connection processing proceeds to a process of 010, and if not, the device connection processing proceeds to a process of 017.

In a process of 009, the GW 2 suspends all the other acquisition processes being executed and advances the device connection processing to a process of 010. In the process of 010, the GW 2 acquires data matched with the acquired profile from the design information (table 24a). The matching between the design information and the profile is made, for example, by matching of the vendor name, the product name, and the function. However, when at least one of the vendor name, product name, and function matches, it can be determined that there is matching data. In this manner, at least one of elements used for a matching condition may be appropriately selected from a plurality of elements included in the attribute.

In a process of 011, the GW 2 determines whether or not there is data matching the profile. If it is determined that there is data matching with the profile, the device connection processing proceeds to a process of 012. If it is determined that there is no data matching with the profile, the device connection processing proceeds to the process of 017.

In a process of 012, the GW 2 searches the configuration information (table 24b) and searches for already connected devices. In a process of 013, the GW 2 determines whether or not the device has already been connected (there is the already connected device). If it is determined that the device has already been connected, the device connection processing proceeds to the process of 017, and if not, the device connection processing proceeds to a process of 014.

In the processing of 014, the GW 2 performs a connection work for handling the provisional connection as a formal connection as necessary (if not necessary, it does nothing). In a process of 015, the GW 2 determines whether or not the connection work is successful. If it is determined that the connection work is successful, the device connection processing proceeds to a process of 016, and if not, the device connection processing proceeds to the process of 017.

In the process of 016, the GW 2 performs the process of updating the configuration information and ends the device connection processing illustrated in FIG. 9. In the process of 017, the CPU 31 of the GW 2 operates as the control unit 21 and determines whether or not link disconnection with the device 1 is possible from the GW 2. When it is determined that link disconnection is possible, the CPU 31 operating as the control unit 21 executes link disconnection processing (018). On the other hand, if it is determined that link disconnection is impossible, the process of FIG. 9 is ended and the link connection is continued. However, the device 1 and the server are in a state in which communication is disabled (communication prohibited). For example, in the GW 2, data from the device 1 is excluded from transmission targets to the server 4.

In this way, when data corresponding to the profile is not found in the design information, the configuration information indicates that a device having the same type has already been accommodated in, or the connection work is failure, a process of prohibiting communication between the device 1 and the server 4, which is a destination of the data from the device 1, is performed. For example, the process of prohibiting is performed by the CPU 31 operating as the control unit 21. As described above, the process of prohibiting includes processing of disconnection of the link between the device 1 and the GW 2 and processing for disabling the communication between the device 1 and the server 4.

### <Communication Between Server 4 and Device 1 (Server 4->Device 1: Downlink Communication)>

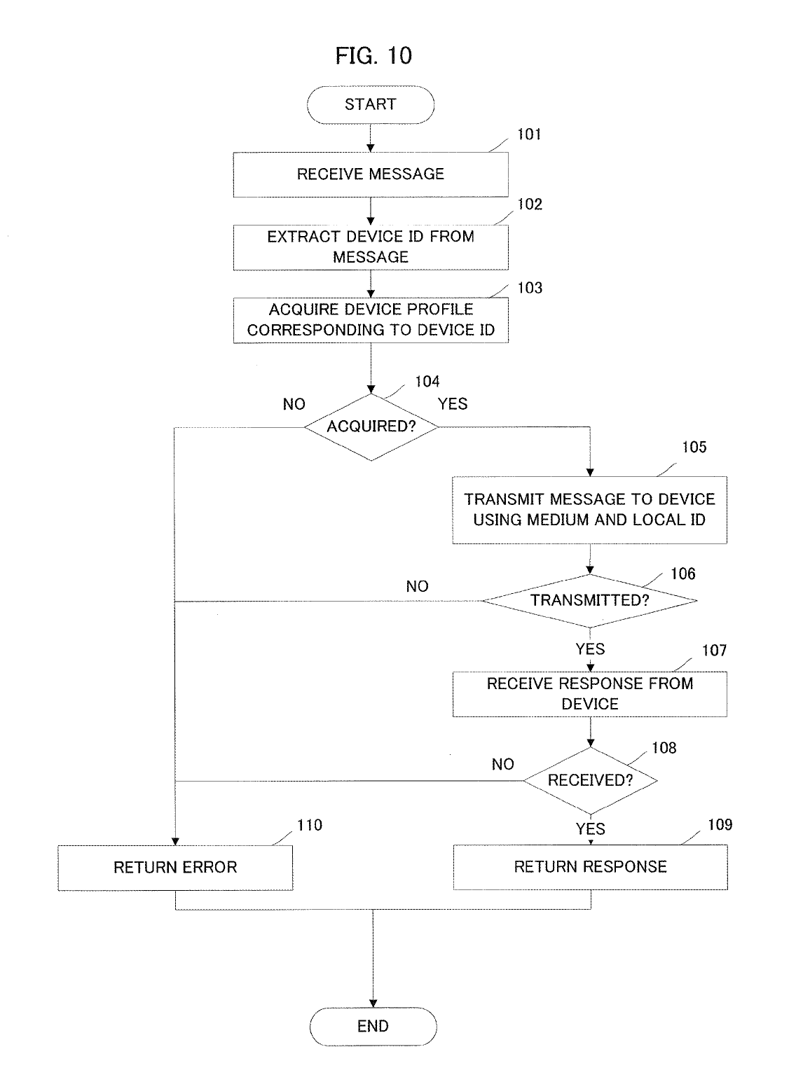

FIG. 10 is a flowchart illustrating the process of GW 2 when the cloud service (server 4) performs data communication with the device 1. The process illustrated in FIG. 10 is executed by the CPU 31 of the GW 2.

In a process of 101, the GW 2 (relay section 25) receives data for data acquisition and device control from the cloud service (server 4). In a process of 102, the GW 2 extracts an identifier (device identifier) for designating a device from the message. In a process of 103, the GW 2 (management unit 24) searches the configuration information (table 24b) and acquires a device profile matching the device identifier.

In a process of 104, the GW 2 determines whether or not the acquisition of the device profile is successful. If it is determined that the acquisition of the profile is successful, the processing in FIG. 10 proceeds to a process of 105, or the processing in FIG. 10 proceeds to a process of 110.

In the process of 105, the GW 2 (control unit 21) transmits a message to the device 1 using the communication medium and the local identifier included in the device profile. In a process of 106, the GW 2 determines whether or not the transmission of the message is successful. If it is determined that the transmission of the message is successful, the processing in FIG. 10 proceeds to a process of 107, or the processing in FIG. 10 proceeds to a process of 110.

In the process of 107, the GW 2 receives a response from the device 1. In a process of 108, the GW 2 determines whether or not reception of a response from the device 1 is successful. If it is determined that the reception of the response from the device 1 is successful, the processing in FIG. 10 proceeds to a process of 109, or the processing in FIG. 10 proceeds to the process of 110.

In a process of 109, the GW 2 transmits a response to the cloud service (server 4), and the processing in FIG. 10 is ended. In the process of 110, the GW 2 transmits an error to the cloud service (server 4), and the processing in FIG. 10 is ended. This is because the device 1 is not accommodated in the GW 2.

<Communication Between the Server 4 and the Device 1 (Device 1->the Server 4: Uplink Communication)>

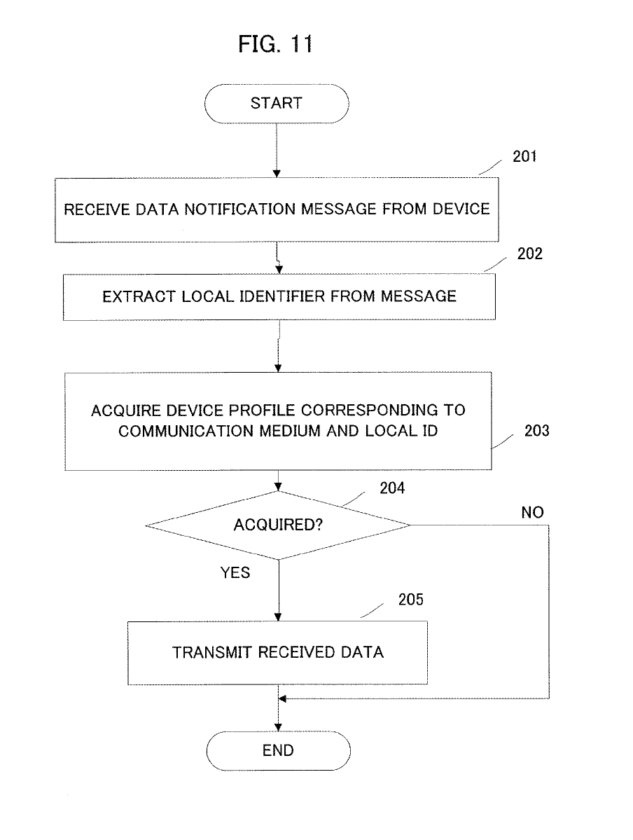

FIG. 11 is a flowchart illustrating the processing of GW 2 when the cloud service (server 4) and the device 1 perform data communication. The processing illustrated in FIG. 11 is performed when the device 1 transmits data to the server 4, and is executed by the CPU 31 of the GW 2.

In a process of 201, the GW 2 receives a data notification message from the device 1. The data notification message includes data addressed to the server 4. In a process of 202, the GW 2 extracts a local identifier from the data notification message. In a process of 203, the GW 2 searches the configuration information (table 24b) and acquires a device profile that a communication medium and the local identifier match.

In a process of 204, the GW 2 determines whether or not the acquisition of the device profile is successful. If it is determined that the acquisition of the device profile is successful, the processing in FIG. 11 proceeds to a process of 205, or the processing in FIG. 11 is ended. In the process of 205, the GW 2 transmits the data received from the device 1 to the cloud service (server 4), and ends the processing of FIG. 11.

<In a Case where a Plurality of GWs is Provided in the System>

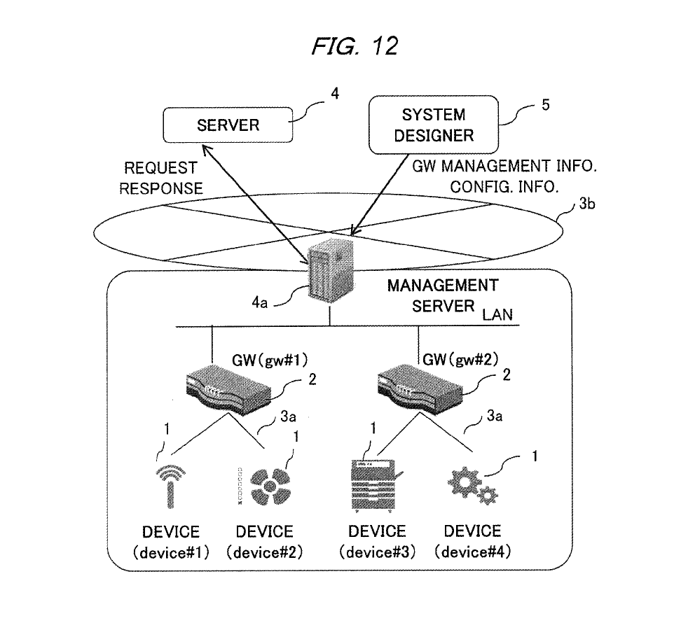

Next, a configuration example in a case where a plurality of GWs 2 is provided in the system will be described. Up to this point, a case where a count of GW 2 is one is exemplified. Depending on the worksite, sum of devices 1 may exceed a count that a single GW 2 is capable of accommodating devices 1. In this case, as illustrated in FIG. 12, a management server 4a for managing a plurality of GWs 2 is installed. The management server 4a may be installed on the network 3b or may be connected to an access network (local network) connected to the network 3b.

The management server 4a manages information such as the IP address of the GW 2, the device 1 accommodated by each GW 2, mediates communication with the cloud service (server 4), and has a function of serving as a window of management for each GW 2. For example, the management server 4a may have the same configuration as the hardware configuration of the GW 2 illustrated in FIG. 2, and the CPU of the management server 4a may design information (table 24 a) and configuration information (table 24 b) of each GW 2.

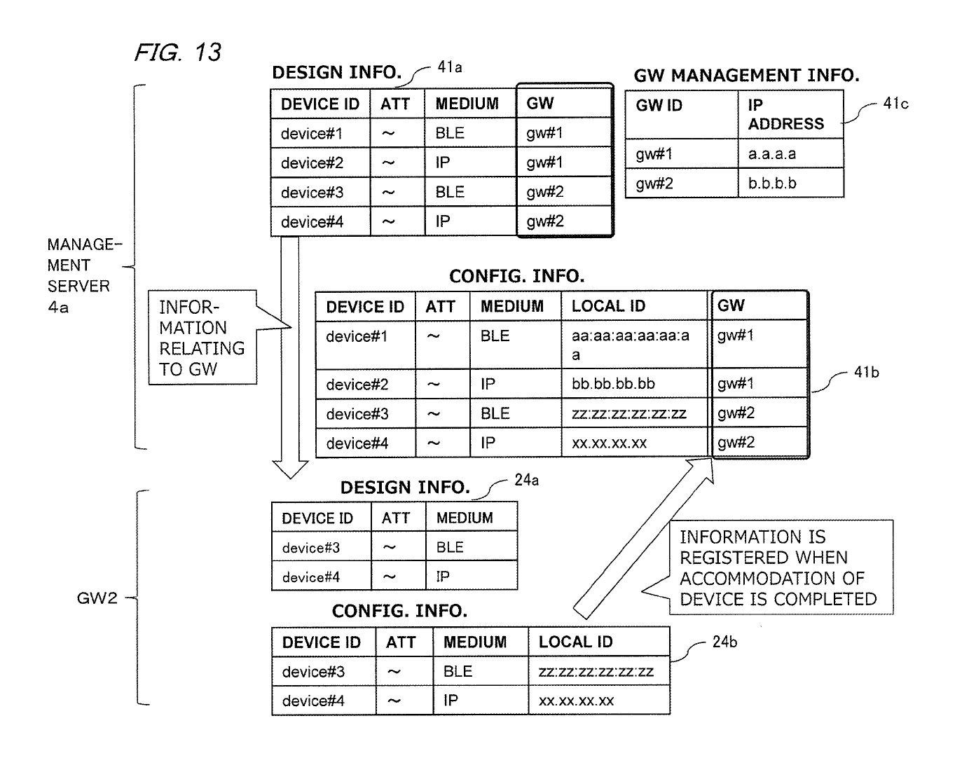

FIG. 13 illustrates a relationship between information managed by the management server 4a and information managed by the GW 2. A table 41a for managing design information, a table 41b for managing configuration information, and a table 41c for managing GW management information are stored in a storage area (at least one of a primary storage and a secondary storage) of the management server 4a. These tables 41a, 41b and 41c are managed by the CPU. The information stored in the table 41c is used when distributing the design information and a service request.

The design information managed by the table 41a and the configuration information managed by the table 41b include an identifier of the GW 2 accommodating the device 1. Each of the GWs 2 receives the design information and the configuration information relating to the device 1 accommodated by each of the GWs 2 from the management server 4a, and manages the design information and the configuration information. The GW 2 transmits updated information to the management server 4a when the configuration information is updated, and the table 41b of the management server 4a is updated.

### Effect of First Embodiment

According to the first embodiment, when the device 1 and the GW 2 are connected, the GW 2 automatically acquires the profile from the device 1. The GW 2 determines whether the acquired profile matches (conforms to) design information stored in advance. The GW 2 outputs a result of determination indicating that connection of the device 1 is permitted when the profile matches the design information, and the GW 2 outputs a result of determination indicating that the connection of the device 1 is impossible when the profile does not match the design information. Based on the determination result of the connection permission, the connection between the device 1 and the GW 2 is maintained, and the GW 2 performs a process of relaying data that is collected by the device 1 and is addressed to the server 4. On the other hand, the device 1 is disconnected from the GW 2 or the communication with the server 4 is disabled based on the determination result of the connection refusal.

In this manner, by connecting the device 1 to the GW 2, the profile of the device 1 is automatically acquired by the GW 2 using a method corresponding to the communication medium. Then, the device 1 that the profile matches the design information is accommodated in the GW 2, and the device 1 that the profile does not match the design information is not accommodated in the GW 2. Since work for obtaining the profile and for inputting the profile to an information processing apparatus or a device is unnecessary, a load of the work for connecting the device 1 to the GW 2 is reduced.

Further, the device 1 that does not conform to the design information is disconnected from the GW 2 or the communication with the server 4 is prohibited. Therefore, it is possible to operate a data collection system with a system configuration conforming to the design information.

In the first embodiment, when the profile matches the design information, the configuration information and the profile information are collated. At this time, when the device 1 having the same type has already been registered in the configuration information (the device 1 is connected to GW 2), disconnection processing of the corresponding device 1 or communication prohibition processing are performed, whereby duplicated connection of devices is avoided. Memorizing of configuration information in GW 2 and collation between configuration information and profiles is an option.

### Second Embodiment

The second embodiment will be described below. Since the configuration of the second embodiment includes in common with the first embodiment, the differences will be described mainly, and descriptions relating to common features will be omitted. In the first embodiment, when connection of the device 1 is permitted, the device profile is registered in the table 24b as configuration information. However, there is a case where management of information relating to an installation location of the device 1 is useful from a viewpoint of asset management of the device 1.

The information relating to the installation location is, for example, a name of the installation location name of the device 1, an image (a picture, a drawing etc.) indicating a place around the installation location of the device 1, an image of the device 1 set at the installation location (an image illustrating an installation state of the device 1), and the like. The information relating to the installation location is useful, for example, when workers perform a work relating to an inventory of the device 1 or a failure of the device 1 on a site. In the second embodiment, when connecting the device 1 to the GW 2, the information relating to the installation location is included (registered) in the configuration information. Thereby, the operation of the data collection system is easier.

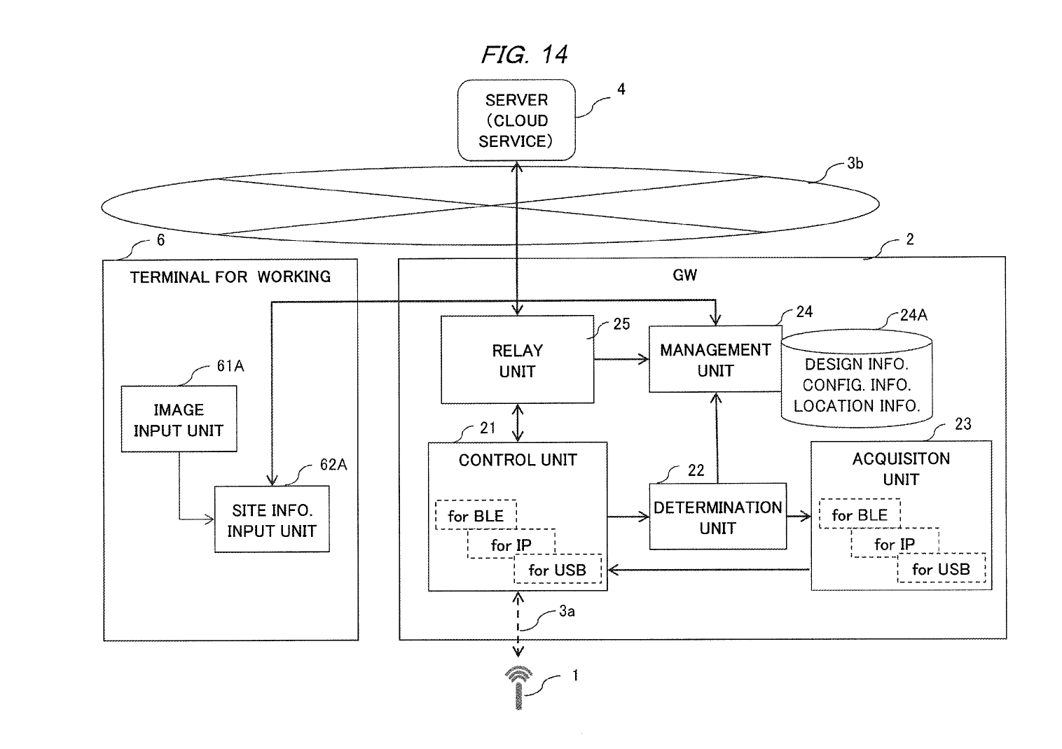

FIG. 14 is a diagram illustrating a configuration example of the second embodiment. As illustrated in FIG. 14, in the second embodiment, a terminal 6 for working (a work terminal 6) used by an operator is added. The terminal 6 is communicably connected to the GW 2 via the network 3b.

The terminal 6 includes an image input unit 61A and a site information input unit 62A. The site information input unit 62A accepts input of information on the installation location of the device 1. The image input unit 61A acquires at least one image of the installation location of the device 1 and at least one image (photograph) of the device 1 installed on the site by photographing. The information and the image indicating the installation location are transmitted to the GW 2 via the network 3b as the information relating to the installation location (installation location relation information). In the GW 2, the management unit 24 registers the installation location relation information in the storage area 24A.

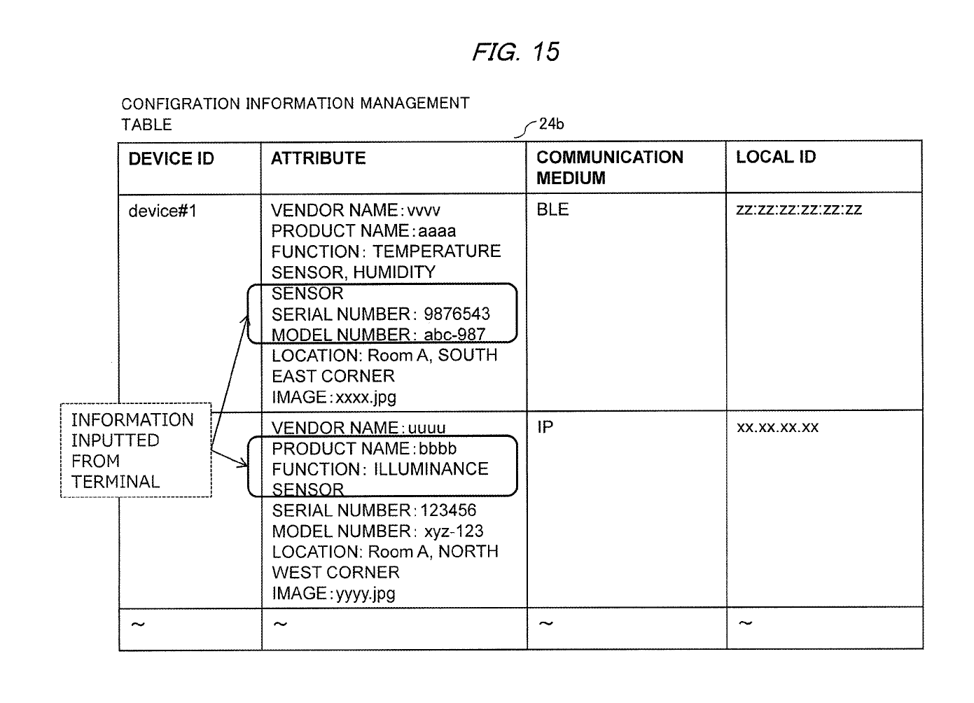

FIG. 15 illustrates an example of the data structure of the configuration information management table 24b in the second embodiment. As illustrated in FIG. 14, in the column of “attribute” of the table 24b, the installation location information and the image (picture) are stored as the installation location relation information.

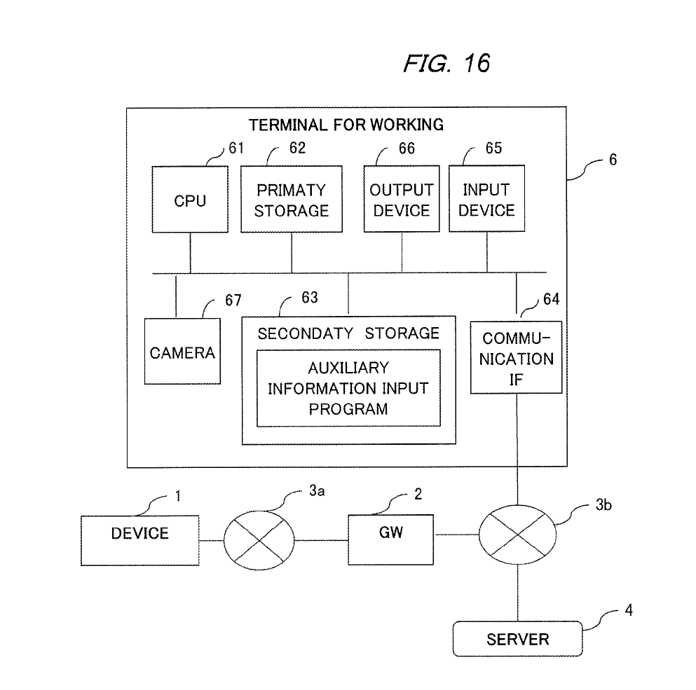

FIG. 16 is a diagram illustrating a hardware configuration example of the terminal 6. As an example, the terminal 6 includes a CPU 61, a primary storage 62, a secondary storage 63, a communication IF 64, an input device 65, an output device 66, and a camera 67. The CPU 61, the primary storage 62, the secondary storage 63, the communication IF 64, the input device 65, the output device 66, and the camera 67 are mutually connected via a bus.

The same things of the CPU 31, the primary storage 32, the secondary storage 33, the communication IF 34b, the input device 35, and the output device 36 illustrated in FIG. 2 may be used as the CPU 61, the primary storage 62, the secondary storage 63, the communication IF 64, the input device 65, and the output device 66

The auxiliary information input program is stored in the secondary storage 63 and/or the primary storage 62. By executing the auxiliary information program by the CPU 61, the terminal 6 operates as an apparatus including the image input unit 61A and the site information input unit 62A. The CPU 61 treats the image (photograph) photographed by the camera 67 and information inputted using the input device 65 as the information relating to the installation location (installation location relation information), controls the communication IF 64, and transmits the installation location relation information to the GW 2 via the network 3b.

An operation example of the second embodiment is as follows. For example, upon execution of the process of 016 (update of the configuration information) in the device connection processing (FIG. 9) described in the first embodiment, the management unit 24 transmits the device profile to the site information input unit 62A and transmits and requires supplemental information.

Before a worker starts a connection work of the device 1, the terminal is communicably connected to the GW2 via the network 3b. In addition, the worker logs in the GW 2 to be worked, and it is prohibited that other workers logs in the GW 2 during the working.

The site information input unit 62A displays a part of the profile of the device 1 (vendor name, product name, etc.) to be connected, on a screen of the output device 66 (display), and the worker is urged to input the information relating to the installation location (information and image (s) indicating the installation location).

The worker takes a picture of the installation place using the camera 67 included in the terminal 6. As a result, the image input unit 61A acquires the image data. The site information input unit 62A accepts the image data and the installation place name (information on the installation location) inputted using the input device 65 and transmits the image data and the installation place name to the management unit 24. The management unit 24 registers the information relating to the installation location in the configuration information of the storage area 24A. The installation location name may be inputted by manual input of the worker at the site. The installation location name may be inputted by selection from candidates registered in a database in advance. The installation location may be determined using a GPS (Global Positioning System) system or the like. The GPS system may be included in the terminal 6 or an apparatus other than the terminal 6.

In the table 24b (see FIG. 15) of the management unit 24, information on “installation location” and an “image (picture)” are added to an item of “attributes” of each device 1. For example, the image data is stored on a file system, and a file name of the image data is managed with the “photo or image” attribute in the table 24b.

According to the second embodiment, the same things as the operation and effect of the first embodiment are obtained, and the information relating to the installation location is included in the configuration information so that the worker refers to the information on the installation location registered in the GW 2. Thereby, the worker's work is more efficient and simplified.

### Third Embodiment

Third embodiment will be described below. Since the configuration of the third embodiment includes in common points with the first embodiment, the differences will be described mainly, and descriptions of common features will be omitted. There may be cases where the design information is changed (updated) during operation of the data collection system (IoT system). For example, by changing contents of the service to be provided, the design information is updated, and a device which is currently used becomes unnecessary or is exchanged into another device.

It is preferable to promptly perform a disconnection operation with the GW 2 and an operation to prohibit communication with the server 4 on the device 1 that is an object of exchange or deletion by updating the design information. If prompt work is not performed, the server 4 does not receive expected data, and the server 4 may perform an illegal operation. The third embodiment solves such a problem.

Since the configuration of the third embodiment is applicable to the configuration similar to that of the first embodiment, illustration thereof is omitted. However, the third embodiment is different from the first embodiment in the following points. That is, the management unit 24 verifies whether or not the entire configuration information matches with the design information, not the individual device unit, and if there is a mismatch, the management unit 24 notifies the control unit 21 of information indicating inconsistency.

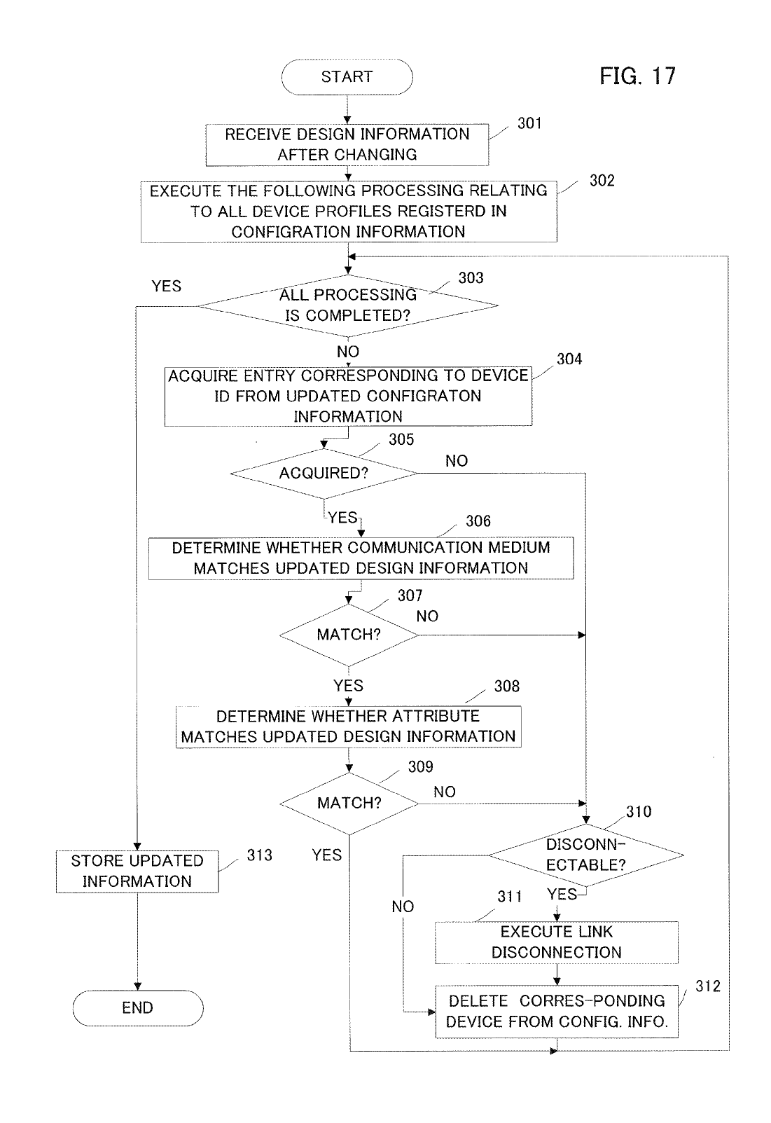

FIG. 17 is a flowchart illustrating a processing example when the design information is updated in the third embodiment. The processing of FIG. 17 is executed by, for example, the CPU 31 operating as the management unit 24. In a process of 301, the GW 2 (CPU 31) receives the updated design information from the system designer 5. In a process of 302, the GW 2 performs the following processing on a record (entry) of each device 1 included in the configuration information (table 24b).

In a process of 303, the GW 2 determines whether or not processing relating to all the device profiles is completed. If it is determined that the processing relating to all the device profiles is completed, the processing of FIG. 17 proceeds to a process of 313. If it is determined that the processing relating to all the device profiles is not completed, the processing of FIG. 17 proceeds to a process of 304.

In a process of 304, the GW 2 extracts a device identifier from an entry of the configuration information, and acquires an entry whose the device identifier matches from the updated design information. In a process of 305, the GW 2 determines whether or not the acquisition of the entry is successful. If it is determined that the acquisition of the entry is successful, the processing of FIG. 17 proceeds to a process of 306. If it is determined that the acquisition of the entry is not successful, the processing in FIG. 17 proceeds to a process of 310.

In the process of 306, the GW 2 determines whether or not a communication medium in the entry matches the communication medium in the updated design information. In a process of 307, the GW 2 determines whether or not a determination result indicating “match” with respect to the communication medium is obtained at 306, and if the determination result indicates “match”, the processing in FIG. 17 proceeds to a process of 308. If the determination result does not indicate “match”, the processing in FIG. 17 proceeds to a process of 310.

In the process of 308, the GW 2 determines whether the attribute in the entry matches the attribute in the updated design information. In a process of 309, the GW 2 determines whether or not a determination result indicating “match” is obtained at 308, and if it is determined that the determination result of “match” is obtained, the processing of FIG. 17 proceeds to the process of 303. If it is determined that the determination result of “match” is not obtained, the processing of FIG. 17 proceeds to a process of 310.

In the process of 310, the GW 2 determines whether or not link disconnection with the device is possible from the GW 2. If it is determined that link disconnection is possible, the GW 2 executes link disconnection processing (311). On the other hand, if it is determined that link disconnection is impossible, the GW 2 deletes information of the corresponding device from the configuration information and returns the processing to the process of 303.

According to the above-described process, the GW 2 extracts the device identifier, and acquires the entry whose the device identifier matches from the updated design information. If the corresponding entry does not exist, the corresponding device is out of a connection target in the updated design information. Therefore, if the communication medium of the corresponding device is a communication medium capable of disconnection processing, the GW 2 executes the disconnection processing and deletes the information of the corresponding device from the configuration information.

If there is a corresponding entry, the GW 2 determines whether the communication medium in the entry matches the communication medium in the updated design information. When the communication medium does not match, the disconnection processing for the corresponding device or the deletion processing from configuration information is performed. When the communication medium matches, the GW 2 performs the same processing as “communication medium” with respect to “attribute” in the entry. Finally, the GW 2 stores (saves) the updated design information.

In the third embodiment, when the design information is updated during the operation of the system, the connection to the GW 2 of the device 1 that does not conform to the updated design information becomes invalid (disconnected from the GW 2, or communication with the server 4 is prohibited). Thereby, stable operation of the system is enabled.

Note that information (entry) relating to the device 1 deleted from the configuration information (table 24b) may be temporarily stored in the primary storage 32 or the secondary storage 33. In this case, the worker is capable of displaying the information temporarily stored on the display of the terminal 6 when removing the device 1 which becomes unnecessary in the site or when exchanging the device 1 into another device, thereby the working is easier.

### Fourth Embodiment

Fourth embodiment will be described below. Since the configuration of the fourth embodiment includes common points with the first embodiment, the differences will be described mainly, and descriptions of common features will be omitted. In the first to third embodiments, it is assumed that all of the profiles (attributes) used for determining whether or not to connect the device 1 to the GW 2 is capable of acquiring by a given method. Therefore, in the first to third embodiments, when the vender name, the product name and the function in the design information match the vendor name, the product name and the function in the profile, it is determined that there is data matching the design information.

However, it is not always true that all devices 1 are implemented so as to be able to provide a complete profile. For example, one or two elements within the above vendor name, product name, and function may not be acquired.

If the connection of the device 1, which does not have the attribute including all of the vender name, the product name and the function, to the GW 2 is prohibited, proper data collection may not be performed, and as a result, proper service provision may not be possible. On the contrary, if connection is permitted unconditionally, a device which is incompatible with the design information will be used, and there is a possibility that appropriate service may not be provided. The fourth embodiment solves such a problem.

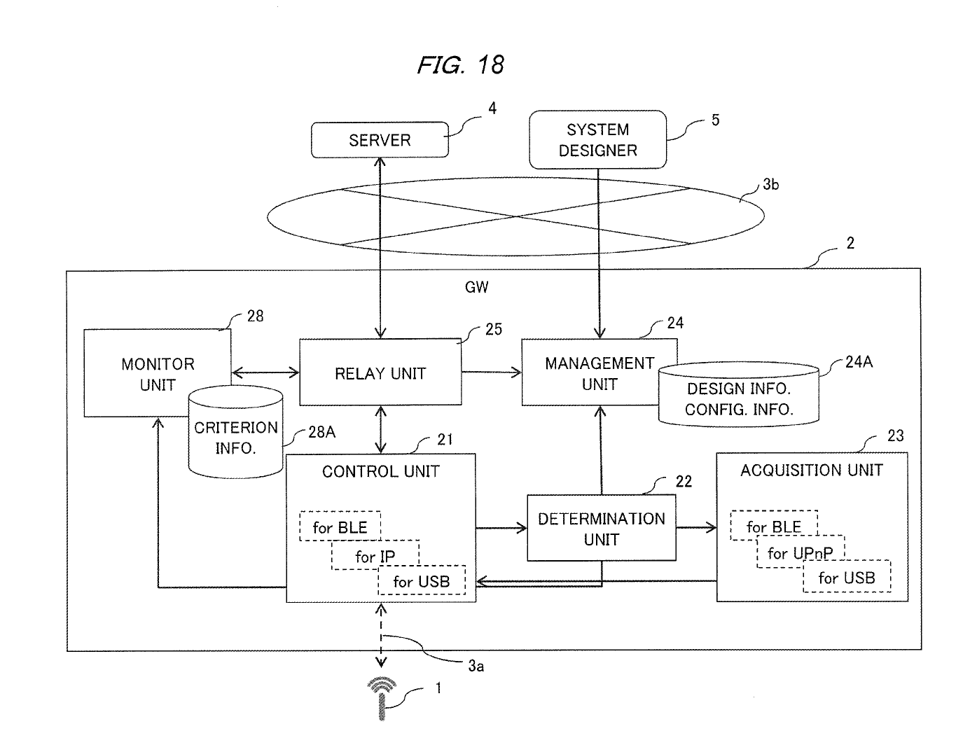

FIG. 18 is a diagram illustrating a configuration example of the GW 2 in the fourth embodiment. The difference from the first embodiment (FIG. 3) is the following. The GW 2 includes a monitoring unit 28 of the device communication. The monitoring unit 28 manages criterion information of a monitoring object stored in the storage area 28A. The criterion information of the monitoring object is determination criterion information (device monitoring policy) of the device 1 as the monitoring object. The storage area 28A is formed, for example, in at least one of the primary storage 32 and the secondary storage 33. The CPU 31 operates as the monitoring unit 28 by executing of the program. The CPU 31 is an example of a “monitoring unit”.

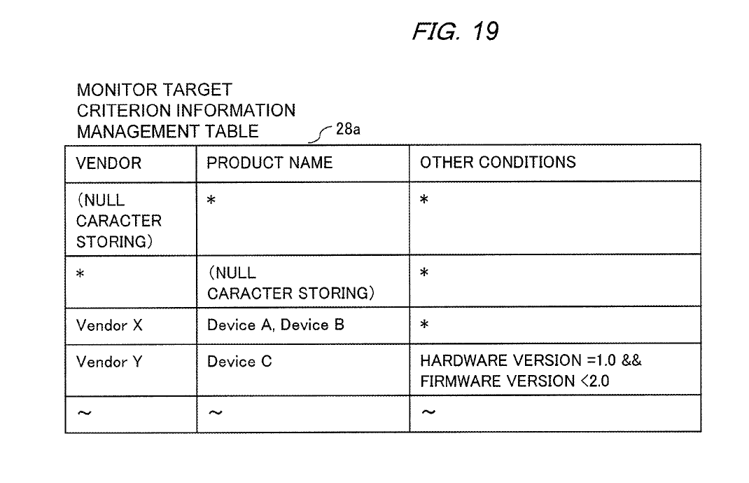

FIG. 19 illustrates an example of the data structure of the table 28a (monitoring object criterion information management table 28a). The table 28a defines devices to be monitored by a combination of information relating to information items “vendor”, “product name”, and “other conditions” which are elements of the profile. Other conditions indicate conditions related to attributes other than vendor name and product name.

For example, the top row (entry) in FIG. 19 is a vendor “null character string”, a product name “* (wild card)”, and other conditions “* (wild card)”. This entry means that all devices for which a vendor name is not obtained are monitoring objects.

The second row (entry) from the top in FIG. 19 is a vendor “* (wild card)”, a product name “null character string”, and other conditions “* (wild card)”. This entry means that a monitoring object is all the devices that acquisition of the vendor name is possible but acquisition of the product name is impossible.

The third row (entry) from the top in FIG. 19 is the vendor “Vendor X”, the product name “Device A, Device B”, and other conditions “* (wild card)”. This entry means that a monitoring object is a device having the product names “Device A” or “Device B” and having the vendor name “Vendor X”.

The fourth row (entry) from the top in FIG. 19 is the vendor “Vendor Y”, the product name “Device C”, the other conditions “hardware version=1.0 &&, firmware version <2.0”. This entry means that monitoring object is the device 1 having the vender name “Vendor Y”, the product name “Device C”, the hardware version is 1.0, and the firmware version is 2.0 or less. Each of three entries registered in the table 28a is an example, and a device satisfying conditions other than conditions indicated by the three example entries may become a monitoring object.

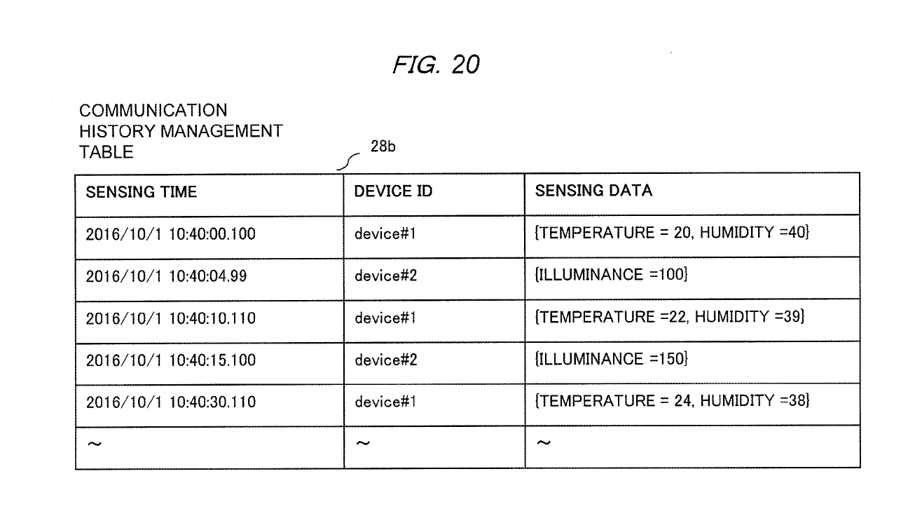

FIG. 20 illustrates an example of the data structure of the communication history management table 28b (table 28b) stored in the storage area 28A. The table 28b is formed by a set of entries including sensing time for data performed by the device 1, the device identifier, and the sensing data. The sensing data is acquired (collected) using the sensor 17, for example.

The sensing time indicates the time when the data was acquired, and the device identifier is an identifier of the device 1 that acquired the data. The sensing data indicates contents of the acquired data.

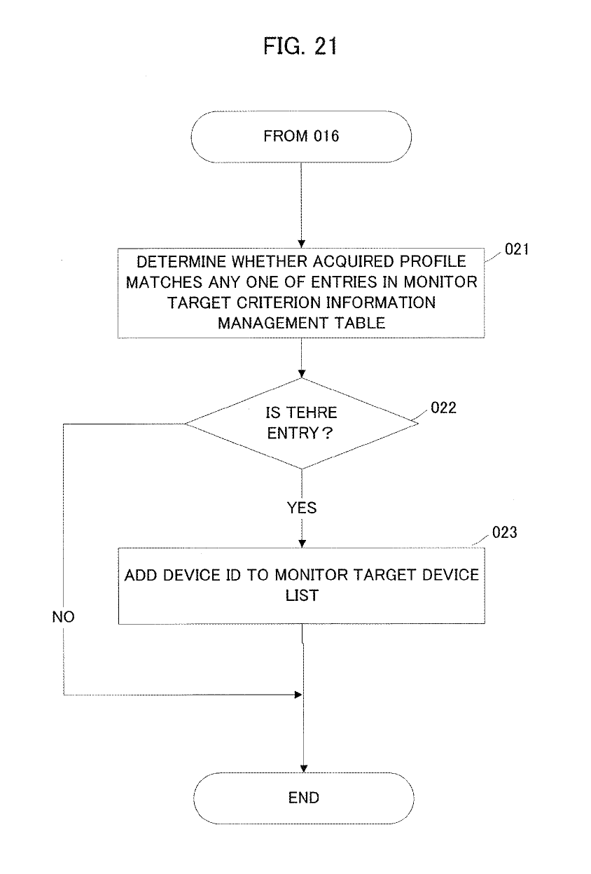

FIG. 21 is a flowchart illustrating an example of device connection processing in the fourth embodiment. In the fourth embodiment, similarly to the first embodiment, the processes of 011 to 016 illustrated in FIG. 9 are executed by the CPU 31. However, after the process of 016, processes of 021, 022, and 023 illustrated in FIG. 21 are executed. In the fourth embodiment, as an example, it is assumed that when at least one of the vendor name and the product name matches between the design information and the profile, the connection of the device 1 to the GW 2 is permitted.

In the process of 021, the GW 2 determines whether the acquired profile matches any one of entries in the table 28a. In the process of 022, the GW 2 determines whether or not there is an entry matching as the determination result of 021. If it is determined that an entry exists, the processing in FIG. 21 proceeds to the process of 023. If it is determined that there is no entry, the processing is ended. In the process of 023, the GW 2 adds the identifier of the device 1 to the monitoring object device list (not shown), and ends the processing. The monitored device list is stored in at least one of the primary storage 32 and the secondary storage 33. When the table 28a has the contents illustrated in FIG. 19, a device that a vendor name is unknown and a device that has a vendor name but a product name is unknown are registered in the table 28b as a monitoring object.

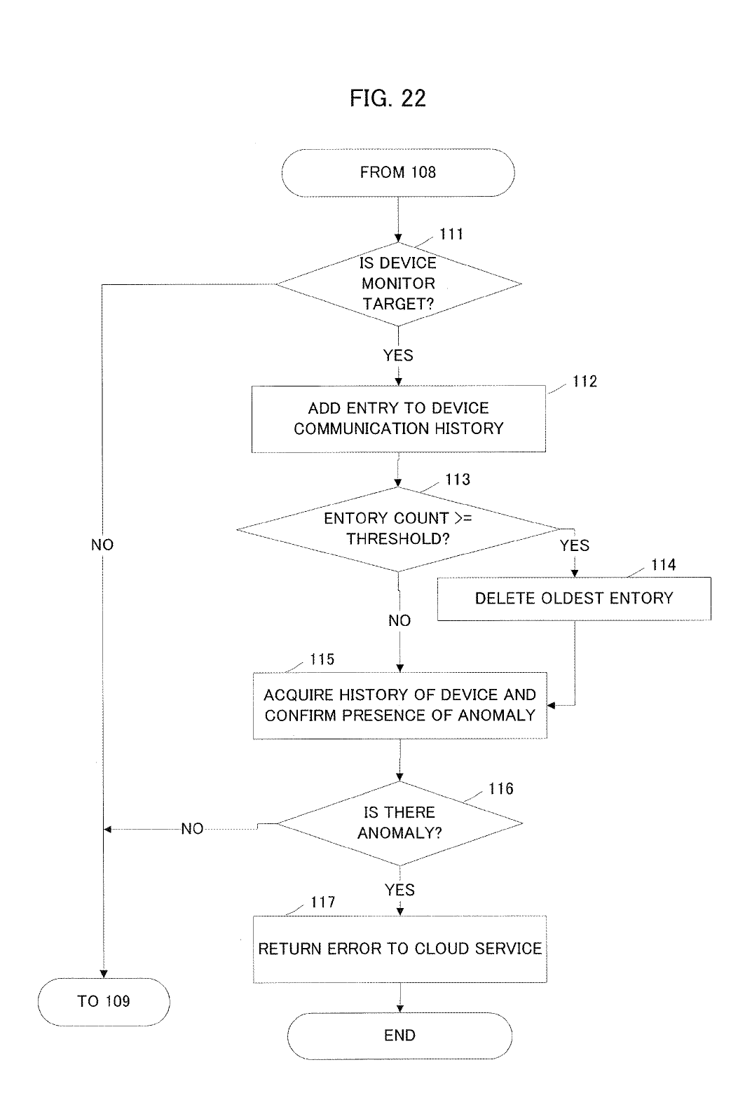

FIG. 22 is a flowchart illustrating an example of monitoring processing performed in the GW 2 according to the fourth embodiment. Also in the fourth embodiment, similarly to the first embodiment, when the server 4 communicates with the device 1, the processes of 101 to 110 shown in FIG. 10 are performed by the CPU 31. However, between the process of 108 and the process of 109, processes from 111 to 117 illustrated in FIG. 22 are added.

The process of 111 is started when a response from the device 1 is received in the process of 108. In the process of 111, the GW 2 refers to the monitored device list and determines whether or not the specified device 1 (which received the response) is a monitoring object. If it is determined that the device 1 is the monitoring object, the processing of the GW 2 advances the process of 112. If it is determined that the device 1 is the monitoring object, the processing of the GW 2 advances the process of 109 (FIG. 10).

In the process of 112, the GW 2 adds an entry (including sensing time, device identifier, sensing data) to the device communication history (table 28b). Information in the entry is included in the response from the device 1.

In the process of 113, the GW 2 determines whether or not a number of entries in the table 28b is greater than or equal to the threshold value. If it is determined that a number of entries in the table 28b is greater than or equal to the threshold value, the processing proceeds to the process of 114. or the processing proceeds to the process of 115. In the process of 114, the entry with the earliest sensing time is deleted from the table 28b. The processing proceeds to the process of 115.

In the process of 115, the GW 2 acquires the communication history of the specified device 1 (receiving the response) and confirms the presence or absence of anomaly. In the process of 116, it is determined whether or not there is an anomaly. If there is an anomaly, the processing proceeds to a process of 117. On the other hand, if there is no anomaly, the processing proceeds to the process of 109 (see FIG. 10). In the process of 117, the GW 2 sends an error to the cloud service (server 4), and the processing is ended.

As described above, in the GW 2 according to the fourth embodiment, when the connection of the device 1 is permitted, the monitoring unit 28 (the CPU 31) acquires the profile from the determination unit 22, and determines whether monitoring of communications of the device 1 is necessary or unnecessary using the profile and the monitoring object criterion information (table 28a).

When it is determined that the device 1 is an monitoring object, the monitoring unit 28 stores the device identifier of the device 1 being the monitoring object in the table 28b and accumulates histories of the communications between the device 1 being the monitoring object and the cloud service (server 4) (see FIG. 20).

The monitoring unit 28 determines the presence or absence of an anomaly of the communications based on the communication histories. The monitoring unit 28 prohibits the communications between the device 1 and the server 4 and sends an error to the server 4 when determining that there is the anomaly. The criterion for determining that the anomaly is presence is that the data transmission interval from the device 1 is different from a preset interval, the data transmission interval is not constant, or a frequency of failure to acquire the data is high. Instead of such a statistical determination criterion, an AI (artificial intelligence) method may be used.

As an example, the processing illustrated in FIG. 22 is executed in synchronization with the processing illustrated in FIG. 10, but the communication anomaly determination processing of the device 1 may be executed asynchronously with processing of messages from the cloud service (server 4).

According to the fourth embodiment, with respect to a device 1 the connection to the GW 2 is permitted, the communication with the server 4 is monitored for the device 1 whose contents of the acquired profile satisfy the predetermined monitoring object condition. When communication anomaly is detected, communication between the device 1 and the server 4 via the GW 2 is prohibited. Thereby, it is possible to give flexibility to a permission range of the connection of the device 1 and to prohibit communications having anomalies. Further, it is possible to avoid unauthorized operation of the server 4.

Since monitoring and analysis increase a load of GW 2, it is conceivable, for example, to monitor a device for a certain period of time using a timer or the like and to exclude the device from the monitoring object if it is confirmed that there is no problem. That is, the monitoring unit 28 is capable of excluding, from the monitoring objects, devices that the anomaly of the communications has not been detected for a predetermined time after becoming one of the monitoring objects. Specifically, when it is determined that there is one or more entries of a certain device in the communication history management table (table 28a), and there is no anomaly in the communications for a given time for the certain device, all of entries of the certain device are deleted from the table 28a. By the deletion, the determination of the process of 111 becomes “No”, the certain device is excluded from the monitoring objects.

Further, in the case where the worker performs final confirmation with respect to the connection work, it may be considered to control whether or not to add the device relating to the connection work to the monitoring objects depending on whether the worker is an expert or not. In this way, by controlling the communication method with the cloud service of the device according to the situation at the time of the connection work such as device identity and skill of the worker, the effect of improving the stability concerning the execution of the cloud service is expected.

### Embodiment 5

The fifth embodiment will be described below. Since the configuration of the fifth embodiment includes the features in common with the first embodiment, the differences will be described mainly, and the description of common features will be omitted. In the first to fourth embodiments, convenience relating to utilization of the device on each service side using the device 1 is not taken into consideration.

However, there are cases where an application (executed on the server 4) providing services has a design that utilization of a specific device is assumed. For example, after starting operation of the service, contents of the application is correspond to a device different from the initially assumed device, and a test in a real environment is performed after performing a test in a development environment.

It is able to be assumed that communication with an unexpected device is prohibited, and a flag is attached to data so that the application easily grasps data from an unexpected device. Then, if processing performed by the application is changed and there is no problem in a field test using flagged data, it may be considered to switch to full-scale operation.

In the fifth embodiment, the communication of the device 1 is controlled based on a result of collating a requirement of the service (server 4) side with the information acquired at the time of connection permission. Thereby, the service operability is improved.

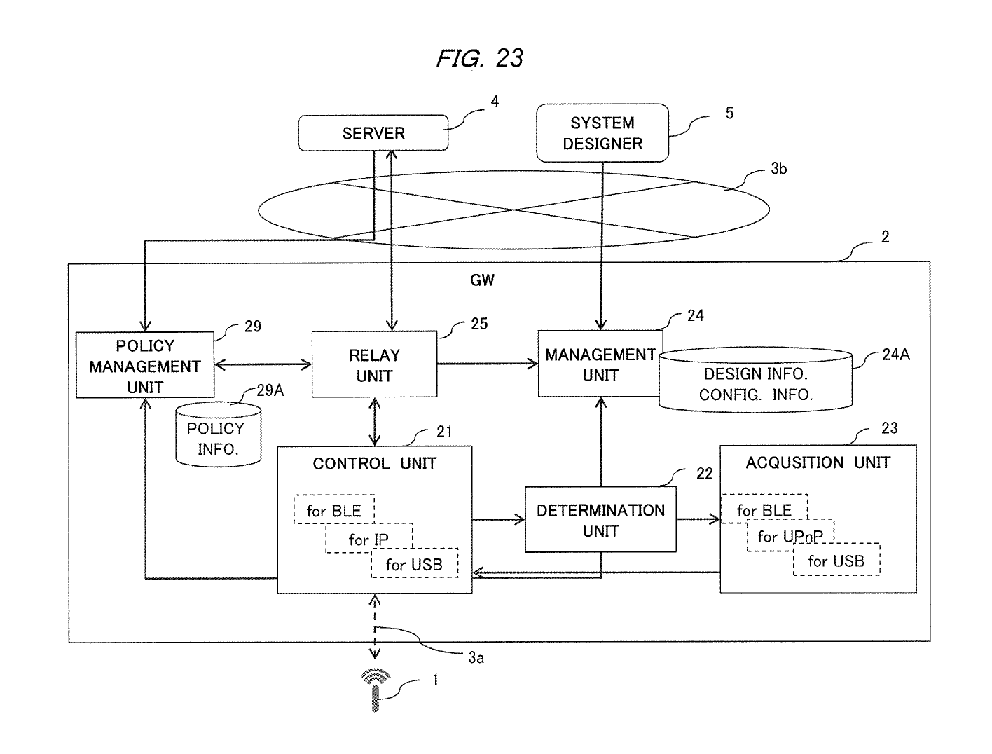

FIG. 23 is a diagram illustrating a configuration example of the fifth embodiment. The GW 2 in the fifth embodiment includes a device communication policy management unit 29 (management unit 29). The CPU 31 operates as the management unit 29 by executing the program. The management unit 29 manages the policy information (policy management table 29a) stored in the storage area 29A. The storage area 29A is provided in at least one of the primary storage 32 and the secondary storage 33. The management unit 29 executes a process relating to a policy determined based on the relationship between the content of the profile of the device 1 specified by the message received from the server 4 and the application executed by the server 4.

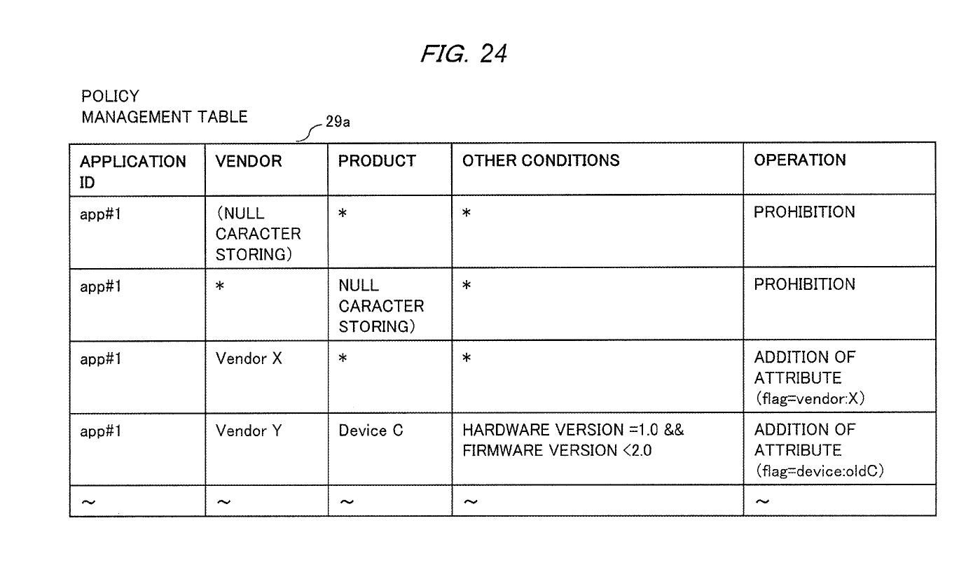

FIG. 24 illustrates an example of the data structure of the policy management table 29a (table 29a). The entry in the table 29a represents a policy defining an action corresponding to a condition satisfied by a device profile. The policy is prepared for each service. The action, for example, may include at least one of prohibition of communications, disabling communications, and adding attributes to data to be transmitted to the application, and the like.

The entry of the table 29a includes an application identifier, a vendor name, a product name, other conditions, and the action. The application identifier is an identifier of the application. The vendor name, product name and other conditions are the same information as in the table 28a. As the action, an action (prohibition of communications, disabling communications, adding attribute, etc.) for the device 1 matching the vendor name, product name and other conditions are defined.

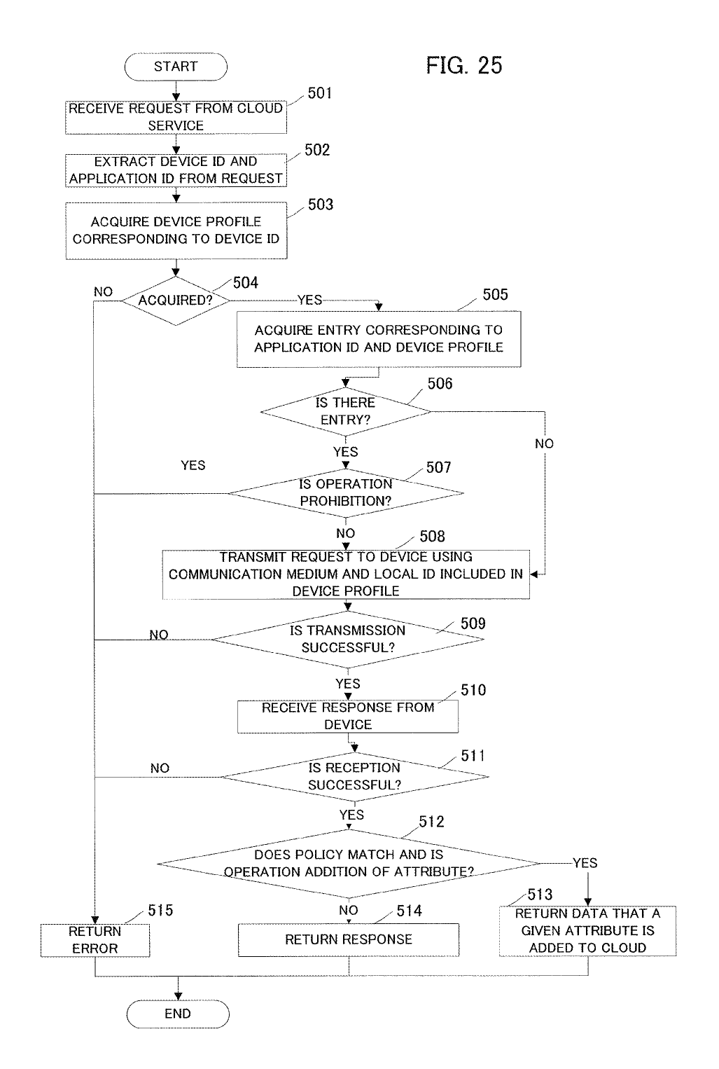

The GW 2 executes processing corresponding to the device 1 at the time of communication between the device 1 and the server 4. FIG. 25 is a flowchart illustrating a processing example of GW 2 at the time of communication between the device 1 and the server 4 in the fifth embodiment. The processing illustrated in FIG. 25 is performed by, for example, the CPU 31 operating as the management unit 29.

In a process of 501, the GW 2 receives a message (request) from the cloud service (server 4). In a process of 502, the GW 2 extracts the device identifier and the application identifier from the message.

In a process of 503, the GW 2 retrieves the configuration information and acquires the device profile corresponding to the configuration information. In a process of 504, the GW 2 determines whether or not the device profile is acquired. If it is determined that the profile is acquired, the processing proceeds to 505. If it is determined that the profile is not acquired, the processing proceeds to a process of 515.

In the process of 505, the GW 2 searches the policy management table 29a and searches for an entry that matches the application identifier and the device profile. In a process of 506, the GW 2 determines whether there is a matching entry or not. If there is a matching entry, the processing proceeds to a process of 507. On the other hand, if there is no matching entry, the processing proceeds to a process of 508.

In the process of 507, the GW 2 determines whether or not the “action” is the “prohibition of communications,” then if it is determined that the “action” is the “prohibition of communications”, the processing proceeds to the process of 515, otherwise the process proceeds to 508.

In the process of 508, the GW 2 transmits the message to the device 1 using the information of the communication media included in the device profile and the local identifier. In a process of 509, the GW 2 determines whether or not the transmission of the message is successful. If it is determined that the transmission of the message is successful, the processing proceeds to a process of 510. On the other hand, If it is determined that the transmission of the message is not successful, the processing proceeds to the process of 515.

In the process of 510, the GW 2 receives a response from the device 1. In a process of 511, the GW 2 determines whether or not reception of a response from the device is successful. If it is determined that the response could be received, the process proceeds to 512. Otherwise, the process proceeds to 515.

In a process of 512, GW 2 determines whether the policy (attributes (vendor name, product name, other conditions)) matches and the action corresponding to the policy is “add attribute” or not. When it is determined that the policy is the “add attribute”, the processing proceeds to a process of 513, and if not, the processing proceeds to a process of 514.

In the processing of 513, the GW 2 adds a given attribute to the data, transmits the data to the cloud service (server 4), and ends the processing. In the process of 514, the GW 2 transmits a response to the cloud service, and end the processing. In the process of 515, the GW 2 sends an error to the cloud service (server 4), and ends the processing.

According to the fifth embodiment, the policy management table 29a in which the contents of the profile information to be detected and the action at the time of detection are defined is prepared for each application executed on the server 4.

For example, the GW 2 sets a policy for prohibiting communications with the application with respect to the device 1 having profile information incompatible with the application identified by the application identifier in the table 29a, so that the device 1 incompatible with the application communicating with the application is avoided.

Alternatively, when data from the device 1 having predetermined profile information is transmitted to the application identified by the application identifier, the GW adds the specific attribute information in the profile information to the data to be transmitted to the application. By the presence of the added attribute information, the application (server 4) is capable of recognizing that the device 1 does not conform to the application, for example. The configurations described in Embodiments 1 to 5 can be appropriately combined.

According to the embodiments, load of connection working of devices is reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus configured to transmit data received from a device to a collection apparatus of the data, comprising:
a memory; and
a processor coupled to the memory and the processor configured to:
acquire profile information of a device that connection to the communication apparatus is requested; and
determine whether or not to permit the connection of the requested device to the communication apparatus based on the profile information and design information of devices accommodated to the communication apparatus.

2. The communication apparatus according to claim 1, wherein the processor is configured to acquire the profile information from the requested device based on a communication medium used for communications the requested device and the communication apparatus.

3. The communication apparatus according to claim 2, wherein the processor is configured to acquire the profile information from the requested device using Device Information Service when the requested device and the communication apparatus perform communications based on Bluetooth Low Energy.

4. The communication apparatus according to claim 2, wherein the processor is configured to acquire the profile information from the requested device using a Universal Plug and Play when the requested device and the communication apparatus perform communications based on Internet Protocol.

5. The communication apparatus according to claim 2, wherein the processor is configured to acquire the profile information from the requested device using a Home-network Topology Identifying Protocol when the requested device and the communication apparatus perform communications based on Internet Protocol.

6. The communication apparatus according to claim 1, wherein the processor is configured to put to the requested device in a state that communications with the communication apparatus is impossible when the requested device has the same type as a device that is in connecting to the communication apparatus.

7. The communication apparatus according to claim 1, wherein the processor is configured to:
receive information relating to installation location of a device to be connected to the communication device; and
generate configuration information including information of the device to be connected and the information relating to the installation location.

8. The communication apparatus according to claim 1, wherein the processor is configured to, when the configuration information is updated, set a state in which a device having profile information that does not match with the updated configuration information is unable to communicate.

9. The communication apparatus according to claim 1, wherein the processor is configured to:
monitor a device having profile information including a given content within devices each of which the connection to the communication apparatus is permitted; and
set a state that communications are impossible to the monitored device when an anomaly of the monitored device is detected.

10. The communication apparatus according to claim 9, wherein the processor is configured to exclude the monitored device that an anomaly is not detected for a predetermined period of time from monitoring objects.

11. The communication apparatus according to claim 9, wherein the processor is configured to execute processing relating to a policy defined based on a relationship between profile information specified by a message received from the collection apparatus and an application executed by the collection apparatus.

12. A communication system, comprising:
a device configured to output data; and
a communication apparatus configured to transmit data received from the device to a collection apparatus of the data, the communication apparatus including:
a memory; and
a processor coupled to the memory and the processor configured to:
acquire profile information of a device that connection to the communication apparatus is requested; and
determine whether or not to permit the connection of the requested device to the communication apparatus based on the profile information and design information of devices accommodated to the communication apparatus.

13. A device, comprising:
a memory; and
a processor coupled to the memory and the processor configured to:
transmit a connection request to a communication apparatus configured to transmit data received from the device to a collection apparatus of the data; and
transmit profile information of the device in response to a request from the communication apparatus.

14. A non-transitory computer readable recording medium having stored therein a program for causing a computer of a communication apparatus to execute a process including:
acquiring profile information of a device that connection to the communication apparatus is requested, the communication apparatus being configured to transmit data received from the device to a collection apparatus of the data; and
determining whether or not to permit the connection of the requested device to the communication apparatus based on the profile information and design information of devices accommodated to the communication apparatus.

15. A communication control method, comprising:
acquiring, by a processor of a communication apparatus, profile information of a device that connection to the communication apparatus is requested, the communication apparatus receiving data forma device and transmitting the data to a collection apparatus of the data, the communication apparatus being configured to transmit data received from the device to a collection apparatus of the data; and
determining, by the processor, whether or not to permit the connection of the requested device to the communication apparatus based on the profile information and design information of devices accommodated to the communication apparatus.
